(19) United States
(12) Patent Application Publication
(10) Pub. No.: US 2025/0391247 A1
(43) Pub. Date: Dec. 25, 2025

(54) GAMING SYSTEMS AND METHODS WITH DYNAMIC GAME ELEMENTS

(71) Applicant: LNW Gaming, Inc., Las Vegas, NV (US)

(72) Inventors: Colbee V. JONES, Reno, NV (US); Kellen DALE, Washoe Valley, NV (US)

(21) Appl. No.: 19/228,376

(22) Filed: Jun. 4, 2025

Related U.S. Application Data
(60) Provisional application No. 63/662,570, filed on Jun. 21, 2024.

(51) Int. Cl. G07F 17/32

(52) U.S. Cl. CPC G07F 17/3267

(57) ABSTRACT

Provided herein is a gaming system that presents symbol-bearing reels, a symbol array, and persistent elements external to the array that each have a respective set of visual states and are uniquely associated with a respective state symbol type. The system generates and presents one or more game outcomes, where each game outcome includes spinning and stopping the symbol-bearing reels to land symbols in the array, animating, in response to the landed symbols including a state change event associated with a first persistent element, the first persistent element and associated state symbols to change from a first visual state to a second visual state, and, in response to detecting a symbol trigger event associated with the first persistent element, presenting a game enhancement sequence for a game enhancement that varies based on the current visual state of the first persistent element.

### CROSS-REFERENCE TO RELATED APPLICATIONS

This application claims the benefit of priority to U.S. Provisional Patent Application No. 63/662,570, filed Jun. 21, 2024, the contents of which are hereby incorporated by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a technological improvement to gaming systems, gaming machines, and methods and, more particularly, to technological improvements in connection with a feature including dynamic presentations of linked game elements.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple game features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to embodiments of the present invention, there are provided a gaming system and method of operating a gaming machine of the system. The gaming system includes game-logic circuitry and a presentation assembly that presents a plurality of symbol-bearing reels, a symbol array, and a plurality of persistent elements external to the symbol array, each of the persistent elements having a respective set of visual states and uniquely associated with a respective state symbol type of the symbol-bearing reels, wherein a current visual appearance of a state symbol is dynamically linked to a current visual state of the associated persistent element. The method includes generating and presenting, via the game-logic circuitry and the presentation assembly, one or more game outcomes, where each game outcome comprises spinning and stopping the plurality of symbol-bearing reels to land symbols from the symbol-bearing reels in the symbol array, in response to the landed symbols including a state change event associated with a first persistent element, animating the first persistent element to change from a first visual state to a second visual state, wherein the current visual appearance of subsequent state symbols associated with the first persistent element is updated to be linked to the second visual state, and in response to detecting a symbol trigger event including at least one state symbol associated with the first persistent element, presenting a game enhancement sequence for a game enhancement applied to at least one game outcome, wherein the game enhancement is associated with the first persistent element and the at least one state symbol and varies based on the current visual state of the first persistent element.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A and 3B are a flow diagram for a data processing method that corresponds to instructions executed by a controller, according to an embodiment of the present invention. FIG. 3A relates to a base-game portion of a wagering game; FIG. 3B relates to a game feature that may be triggered during play of the base game.

FIG. 4 is an exemplary presentation of a base-game spin outcome resulting from the flow diagram in FIG. 3A.

FIG. 5 is an exemplary game interface using state-based persistent elements, according to one or more embodiments of the present invention.

FIG. 6 depicts a series of exemplary states of a persistent element shown in FIG. 5, according to one or more embodiments of the present invention.

FIG. 7 depicts a flow diagram of an example method of operating a gaming machine of a gaming system, according to one or more embodiments of the present invention.

FIG. 8A depicts an example game interface in a first state including state symbols, according to one or more embodiments of the present invention.

FIG. 8B depicts the game interface of FIG. 8A in a second state with a newly upgraded persistent element, according to one or more embodiments of the present invention.

FIG. 8C depicts the game interface of FIG. 8A in a third state transitioning from a base game to a bonus game instance, according to one or more embodiments of the present invention.

FIG. 8D depicts the game interface of FIG. 8A in a fourth state with an initial bonus game outcome of the bonus game instance, according to one or more embodiments of the present invention.

FIG. 9 depicts the game interface of FIG. 8D within a first example game enhancement sequence for populating symbol positions with value-bearing symbols, according to one or more embodiments of the present invention.

FIG. 10A depicts the game interface of FIG. 8D within a second example game enhancement sequence using award regions, according to one or more embodiments of the present invention.

FIG. 10B depicts the game interface of FIG. 10A presenting a subsequent bonus game outcome including a value-bearing symbol within an award region, according to one or more embodiments of the present invention.

FIG. 10C depicts the game interface of FIG. 10A presenting the second game enhancement with additional value-bearing symbols within the award region, according to one or more embodiments of the present invention.

FIG. 11A depicts the game interface of FIG. 8D within a third example game enhancement sequence for multipliers to value-bearing symbols, according to one or more embodiments of the present invention.

FIG. 11B depicts the game interface of FIG. 11A presenting a multiplier to be applied to value-bearing symbols within the symbol positions, according to one or more embodiments of the present invention.

FIG. 11C depicts the game interface of FIG. 11A presenting the resulting value-bearing symbols following the multiplier application in FIG. 11B, according to one or more embodiments of the present invention.

FIG. 12 a series of exemplary states of a persistent element and corresponding state symbol represented by a monster avatar, according to one or more embodiments of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

As used herein, the term “potential value” refers to a theoretical maximum value achievable through a particular game event for the purposes of comparing the game event to other game events. The potential value is considered within ideal external conditions, such as other game symbols and game elements being configured to facilitate the theoretical maximum value. For example, a game event associated with a 2× multiplier has a lower potential value than the same game event associated with a 3× multiplier. Having a greater potential value does not necessarily mean a game event will always have a greater award relative to another game event, if any award is provided at all. That is, the potential value is independent of a game outcome and the underlying symbols and/or other game elements. A first game event having a lower potential value than a second game event may still have a higher value within a particular game outcome based on the game elements forming the outcome. For example, using the above example with two game events having a 2× and a 3× multiplier, the 2× game event may have a higher actual value than the 3× game event if the 2× multiplier is applied to more symbols and/or higher value symbols within a given game outcome. It is to be understood that the term “value” is not limited a credit value but can additionally or alternatively refer to other forms of value, such as increased probability of triggering a game event or award, awarding additional symbols, spins, and the like, and/or advancing progression towards a persistent game event. Although the potential value is referred to as a “theoretical maximum value” above, the potential value can be adaptable to alternative definitions that enable those skilled in the art to readily compare and rank game events within a game, particularly game events that are associated with different states or stages of a dynamic game feature.

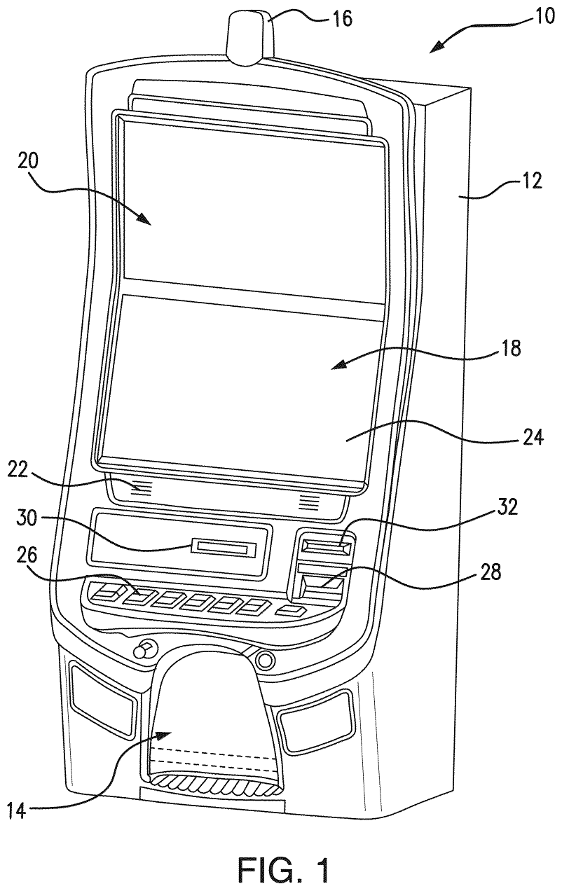

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

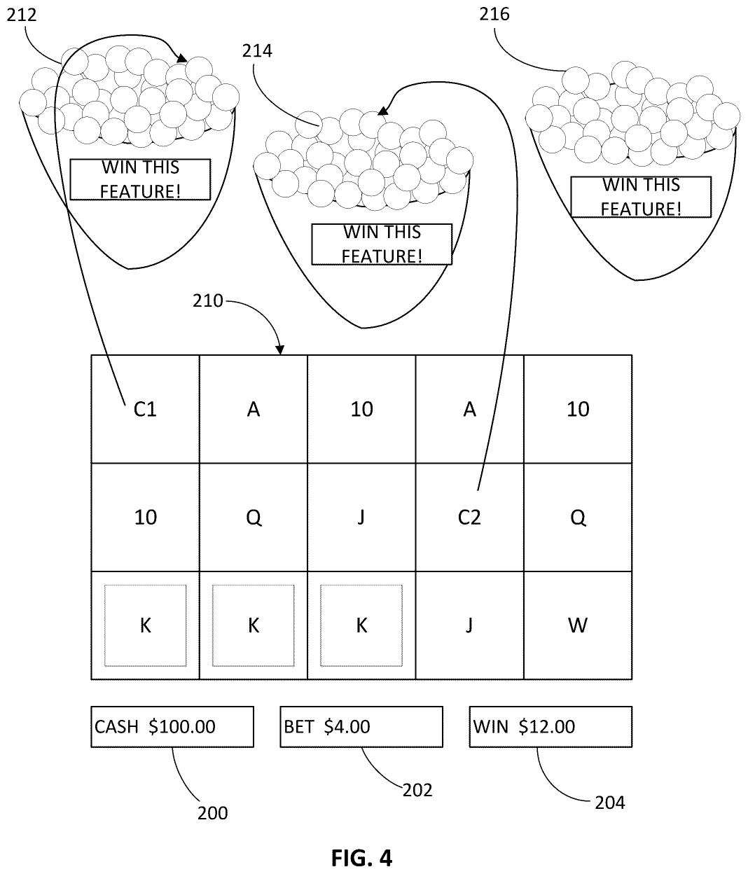

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

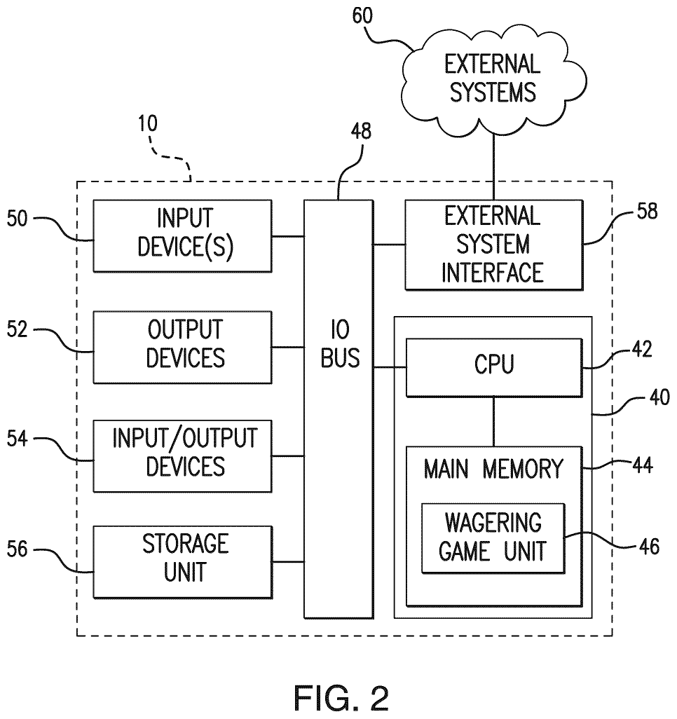

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40-whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

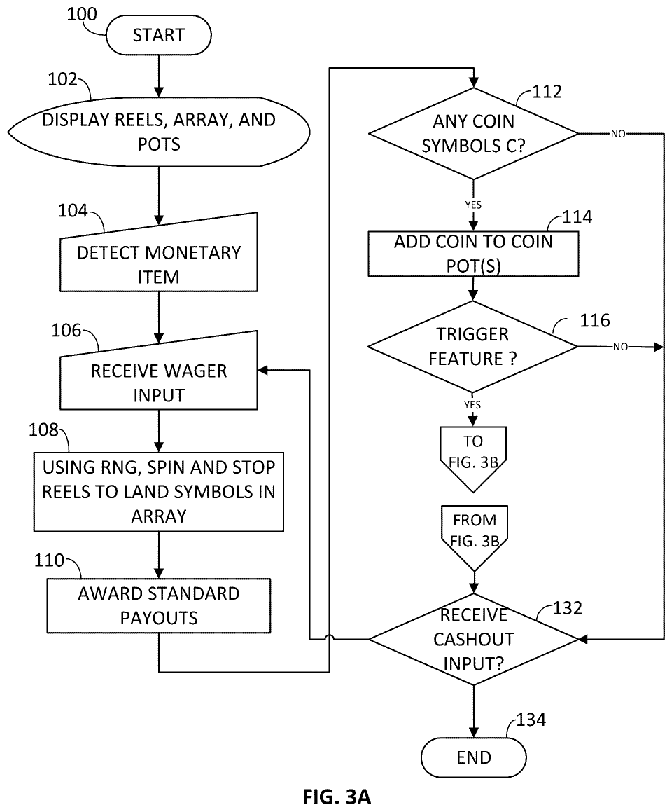

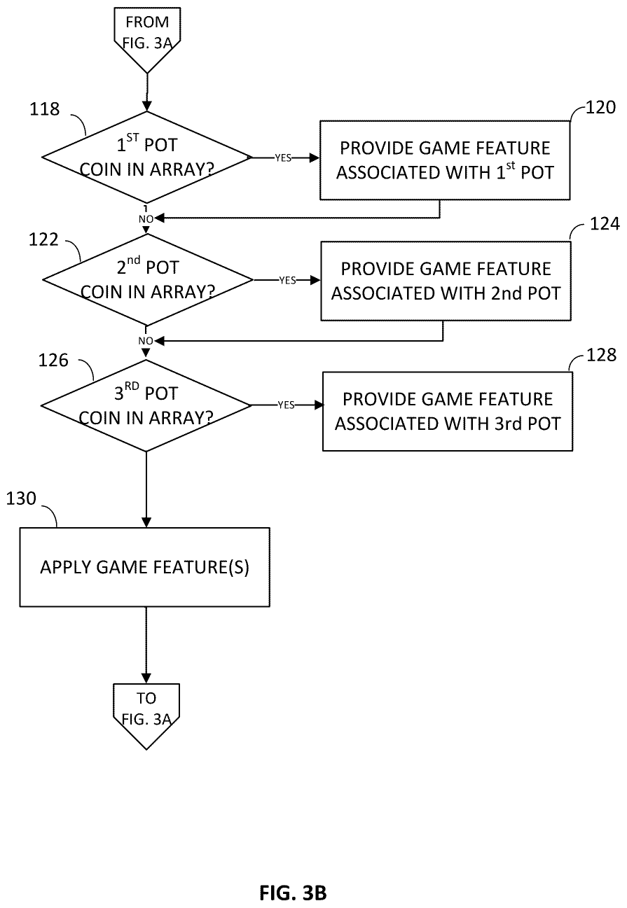

Referring now to FIGS. 3A-3B, there is shown a flow diagram representing one data processing method corresponding to at least some instructions stored and executed by the game-logic circuitry 40 in FIG. 2 to perform operations associated with a persistent element game feature. The data processing method is described below in connection with the exemplary presentation of a spin outcome in FIG. 4.

Referring to FIG. 3A, the data processing method commences at step 100. At step 102, the game-logic circuitry controls one or more presentation devices (e.g., mechanical-reel display device, video display device, or a combination thereof) to present a plurality of symbol-bearing reels, an array of symbol positions, and a feature-triggering perceived persistent element (e.g., one or more coin pots). Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In some embodiments, the reels are associated with respective individual symbol positions of the array such that each reel animates in place and populates only its respective symbol position. The symbol array configuration may vary between the base game and any bonus games and/or other game features utilizing the array.

In FIG. 4, the symbol array 210 in the base game has a three-by-five rectangular configuration, and each symbol position is associated with a respective independent reel. The reels bear a plurality of symbols that may, for example, include royal symbols 10, J, Q, K, and A; a wild symbol W that can substitute for any of the royal symbols; and generic coin symbols C1, C2, C3.

In one or more embodiments, the plurality of symbols also includes value-bearing symbols, otherwise known as WYSIWYG (“What You See is What You Get”) or “cash on reels” symbols. Each value-bearing symbol is associated with a credit or currency value indicated on the symbol itself. The value on a particular credit-bearing symbol may be fixed or variable (e.g., random) from one game cycle to the next. Different value-bearing symbols on the reels may have different values. In one or more embodiments, a value-bearing symbol may be associated with a value determined or displayed separately. For example, rather than a specific amount, a GRAND, MAJOR, MINOR, or MINI award label may be indicated on a value-bearing symbol. Each reel may contain one or more stacks (i.e., clumps) of value-bearing symbols that appear adjacent to each other along the reel. The values of the value-bearing symbols in any given stack may be the same or different. A stack of value-bearing symbols may consist of two, three, four, or more adjacent symbols. Further, adjacent reels may contain one or more “mega” value-bearing symbols that move as one block as the reels spin. When the spin is complete, each individual row and column of the array underlying any visible portion of the “mega” symbol is assigned the value associated with the “mega” value-bearing symbol. For example, a “mega” value-bearing symbol may comprise two-row high square spanning the first two columns of the array 210. If this symbol stops aligned with the top two rows of the array 210, the symbols in the first two rows and first two columns would all be treated as though individual value-bearing symbols having the value of the “mega” symbol had landed in those locations.

At step 104, the game-logic circuitry detects, via a value input device, a physical item associated with a monetary value that establishes a monetary balance in the form of cash or credits. In FIG. 4, the monetary balance may be shown on a meter 200.

At step 106, the game-logic circuitry initiates a base game of a wagering game cycle (i.e., spin cycle) in response to an input indicative of a wager covered by the monetary balance. To initiate a spin of the reels, the player may press a “Spin” or “Max Bet” key on a button panel or touch screen. In FIG. 4 the wager may be shown on a bet meter 202.

At step 108, using an RNG, the game-logic circuitry spins and stops the reels to randomly land symbols from the reels in the array in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display. Alternatively, the reels may be physical/electromechanical reels. FIG. 4 depicts a base-game spin outcome.

At step 110, the game-logic circuitry awards standard payouts in accordance with a pay table. The pay table may, for example, include “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay. FIG. 4, for example, depicts a line pay of three K symbols in the bottom row of the array 210. The awarded pay is added to a win meter 204.

At step 112, the game-logic circuitry determines whether or not any coin symbols C1, C2 or C3 landed in the array. If a coin symbol C1, C2 or C3 did not land in the array, the game-logic circuitry immediately proceeds to step 132. If, however, one or more coin symbols C1, C2 or C3 landed in the array as shown in FIG. 4, the game-logic circuitry proceeds to step 114. At step 114, the game-logic circuitry animates the addition of each coin symbol C1, C2 or C3 to a persistent element such as a coin pot (FIG. 4; 212, 214, 216) associated with the respective coin symbol C1, C2 or C3. For example, the coin symbol C2 in the center column of FIG. 4 may be animated to “fly” off the array and land in the middle of its associated coin pot 212. To represent the addition of the coin symbol to the coin pot, the pot and/or the volume of coins therein may appear to grow in size. In FIG. 4, the transfer of the coin symbol C2 to the middle coin pot 214 is represented by an arrow. The persistent elements may take forms other than the coin pots 212, 214, 216, including for example urns, vases, jars, jugs, cans, bowls, piggy banks, beehives, inflating balloons, ladders, dials, meters, etc. In accordance with some embodiments, the persistent element may be an object of fixed size accompanied by some other indication of accumulating value, for example, by a gradual change in color. In other embodiments, the persistent element may change size and also show some other indication of increasing value, for example, the color of the display in the immediate area of the persistent element may gradually change as its value increases.

During a player's gaming session, the growth in size of the coin pots 212, 214 216 in FIG. 4 may persist from one wagering game cycle to the next such that the player perceives that the corresponding game feature may be getting closer to being triggered. This kind of game is known as a “perceived persistence” game. Unlike a true “persistence game,” wherein the size of each coin pot or the observable quantity of its contents serves as an indication of the probability that its associated bonus or game feature will be triggered. In both cases, when the bonus or game feature associated with a pot is triggered, at least some of the contents of the pot are visually removed and the accumulation of coins in that pot during subsequent game spin cycles resumes from that point.

In the perceived persistence embodiments described here, at step 116, if at least one coin symbol C1, C2, or C3 appears in the array, the game-logic circuitry randomly determines, via the RNG, whether or not to trigger one or more game features of varying types, described below. This random determination is independent of any prior wagering game cycles.

In some embodiments, a game feature simply awards a prize, for example a fixed or progressive jackpot amount.

In some embodiments, a game feature may comprise any type of bonus game. The term “bonus game” as used herein refers to a game feature that functions through additional, fewer, or alternative game logic and/or game elements relative to the base game feature. Non-limiting examples of bonus games include a certain number of free games (i.e., spins of the reels), a “pick'em” bonus game, a wheel-spinning game, etc. In embodiments offering a free spin bonus game, the free spins may be played as a “hold and spin” game in which certain types of symbols, once landed in the array, are held in place, and persist in the array for at least one additional free spin cycle. These persistent symbols may include value-bearing (“WYSIWYG”) symbols, wild symbols or other symbols that may improve the chances of winning or provide higher pays. In still other embodiments, a bonus game may be played to determine a game enhancement (described further below) or payment of prize, for example, a fixed or progressive jackpot (described above). The game enhancement may be applied to an outcome of the bonus game, the current base game or one or more future play cycles of the same bonus game, a different bonus game or the base game.

In some embodiments, a game feature may comprise an enhancement to the game. An enhancement may include, without limitation, pay table modifiers such as multipliers, increased values on value-bearing symbols, modification to the reels to include improved symbols, such as wild symbols or symbol weights or the removal of certain “blocking symbols”, additional rows or columns added to the array, additional free spins, replacement symbols for symbols already present in the array, etc. The enhancement may be applied to the current base game outcome or may be applied to one or more subsequent game features or wagered base game plays.

If a game feature is not triggered at step 116, the spin cycle is complete, and the game-logic circuitry proceeds to step 132. If, however, a game feature was triggered at step 116, the game-logic circuitry instead proceeds to the flow in FIG. 3B to determine which of one or more game features have been won according to the specific coin C1, C2 and C3 present in the array.

At step 118 in FIG. 3B, the game logic circuitry determines if a coin C1 associated with the left pot 212 is present in the array. If not, the method proceeds to step 122, otherwise, a game feature associated with the left pot 212 is enabled at step 120.

At step 122, the game logic circuitry determines if a coin C2 associated with the middle pot 214 is present in the array. If not, the method proceeds to step 126, otherwise, a game feature associated with the middle pot 214 is enabled at step 124.

At step 126, the game logic circuitry determines if a coin C3 associated with the right pot 216 is present in the array. If not, the method proceeds to step 130, otherwise, a game feature associated with the middle pot 214 is enabled at step 128.

Depending on which coins C1, C2 and C3 are present in the array, it is possible for more than one of the above-described game features to be applied to the game. For example, the left pot 212 may award a pay table multiplier as its associated game feature and the middle pot 214 may simultaneously award a game feature of extra free spins as its associated game feature. In this example, when the enhanced game feature spin cycles are played, both enhancements will be in effect. That is, each enhanced game feature spin cycle will benefit from the pay table multiplier.

Each game feature has a different impact on the expected value (EV) of the game. The relative frequency of the game features may be controlled by adjusting how frequently the associated coins C1, C2 and C3 appear in the array, for example, by their relative weighted appearances on the reels. Thus, a less lucrative game feature may be won more frequently, for example, approximately once in every ten game spin cycles, while a higher paying game feature may only occur approximately once in every one hundred game spin cycles. This allows game features to be triggered more often, for player enjoyment, while maintaining the overall expected EV of the wagering game.

To present a game feature and any enhancements enabled in steps 118-128, at step 130 the game-logic circuitry may control one or more presentation devices (e.g., mechanical-reel display device, video display device, or a combination thereof) to present a bonus game array. The bonus game array may have the same configuration as the base game array or may have a different configuration than the base game array.

At step 132 of the game feature, using an RNG, the game-logic circuitry spins and stops symbol-bearing bonus reels to randomly land symbols from the reels in the bonus game array. Each symbol position of the array may be associated with a respective independent reel. The reels bear a plurality of bonus symbols that may, for example, include blanks (i.e., no indicia). The reel spin may be animated on a video display by depicting symbol-bearing strips moving vertically across the display and synchronously updating the symbols visible on each strip as the strip moves across the display. Alternatively, the bonus reels may be physical/electromechanical reels.

At step 132, the game-logic circuitry determines whether or not it has received a cashout input via at least one of the one or more player input devices of the gaming machine. If it has not received a cashout input, the game-logic circuitry waits for the next wager input at step 106. If it has received a cashout input, the game-logic circuitry initiates a payout from the monetary balance on the meter 200 in FIG. 4. The data processing method then ends at step 134.

Embodiments of the present invention realize benefits in increased computer processing efficiency with minimized processing overhead, fewer rules to be evaluated, fewer player inputs to be monitored, and simpler graphical representations. With respect to the game feature triggering process, if no coin symbol C1, C2 or C3 appears in the array at step 112, the game-logic circuitry foregoes any random determination of whether a game feature will be awarded. Furthermore, if any coin symbols do appear in the array, regardless of the number of pots and associated game features that may be won in parallel, only a single invocation of the RNG at step 116 is required to determine whether any game feature will actually be triggered. In contrast, in typical prior art systems with mystery bonus triggers, the game-logic circuitry makes a random determination in each and every wagering game cycle and for each and every game feature that may be won, thereby reducing processing efficiency compared to the method presented herein.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

The systems and methods described herein include state-based persistent elements and symbols linked together to provide dynamic game features, which may be used for operating gaming systems similar to (or different from) the systems and methods shown in FIGS. 3A-4. More specifically, a persistent element has several available states that each have a corresponding presentation and game enhancement appliable to a game or game feature of the gaming system. The persistent element is associated with one or more state symbols presentable within a plurality of symbol positions (e.g., a symbol array) of a game interface, where the state symbols are visually linked to the current state of the persistent element and may be used to trigger and/or apply the game enhancement to one or more game outcomes. For example, if the game enhancement includes applying multipliers to symbols within a game outcome, the multipliers may be applied to symbols based on a relative position of the state symbol within the symbol positions.

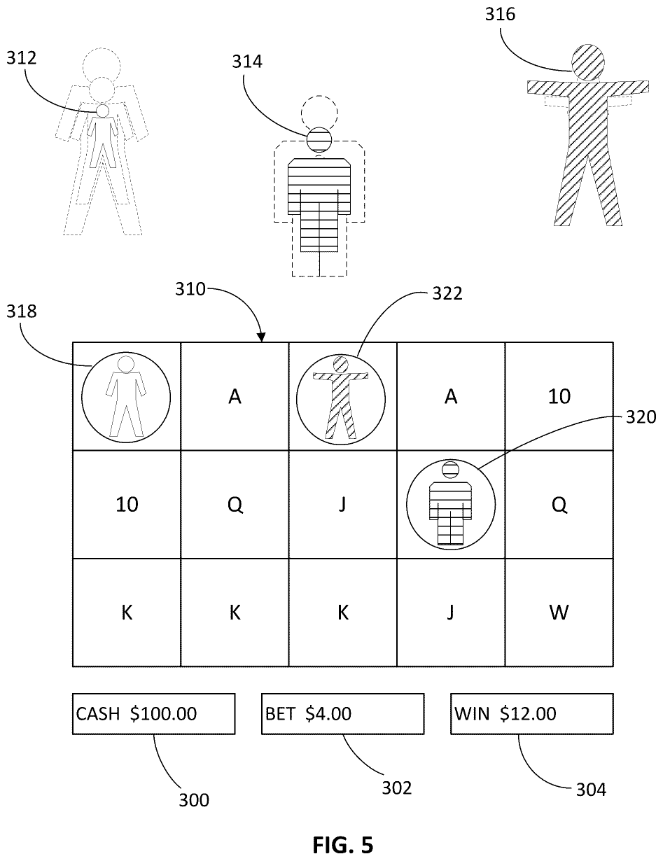

FIG. 5 depicts an exemplary game interface including state-based persistent elements that is presented by a gaming machine of a gaming system. The game interface is similar to the interface shown in FIG. 4 and includes a credit meter 300, a bet meter 302, a win meter 304, a symbol array 310, and a plurality of persistent elements 312, 314, 316 external of the symbol array 310. In other embodiments, the game interface may include additional, fewer, or alternative game and/or presentation elements in a similar or different configuration. For example, the game interface may include a different number of persistent elements, such as one, two, five, and the like.

In the example embodiment, the symbol array 310 is filled with randomly selected symbols to form a game outcome. The symbols are selected from one or more sets of available symbols, and the gaming system includes game-logic circuitry (e.g., the game-logic circuitry shown in FIG. 2) that generates one or more random values or other random determinations to select systems from the sets of available symbols. In some embodiments, the sets of available symbols represent symbol-bearing reel strips associated with one or more symbol positions of the array 310 (e.g., a respective single position or a column of the array 310). The symbol selection may be weighted to alter the relative probability of selecting a certain symbol or reel stop position over another for a given game outcome. In certain embodiments, the symbols and/or reel stop positions are stored in one or more weighted tables, where a random value generated by the game-logic circuitry is compared to the weighted table to identify a selected symbol or reel stop position.

The symbols populating the array 310 include several state symbols 318, 320, 322 that are linked respectively to one of the persistent elements 312, 314, 316. More specifically, the first persistent element 312 is linked to the first state symbol 318, the second persistent element 314 is linked to the second state symbol 320, and the third persistent element 316 is linked to the third state symbol 322. In the example embodiment, each persistent element 312, 314, 316 is linked to one respective state symbol type as shown in FIG. 5. In other embodiments, additional or alternative state symbol types may be included within the sets of available symbols, such as a state symbol type associated with a plurality of persistent elements, or a state symbol associated with the same persistent element but a different game enhancement as described herein.

In the example embodiment, each of the persistent elements 312, 314, 316 are presented as different avatars with three respective states represented by the avatar changing in size and pattern. The states are organized into a progressive path, where the states “increase” or “evolve” from a first state to a second state and finally to a third state. Visually, in the example embodiment, the progressive path is indicated to players by progressively increasing the size of the avatar for each state (see, e.g., the dotted outlines for each persistent element 312, 314, 316 depicting the states other than the current state of each element) and changing the pattern of the avatar. In the illustrated game state, the first persistent element 312 is in a first state with a relatively small avatar and no pattern fill, the second persistent element 314 is in a second state with an increased avatar size relative to the first state and a horizontal pattern fill, and the third persistent element 316 is in a third state with an even greater avatar size relative to the first and second states and a diagonal pattern fill.

The state symbols 318, 320, 322 are visually linked to the current state of the respective persistent element 312, 314, 316. That is, the state symbols have a dynamic presentation that matches, aligns with, or otherwise visually conveys to players which persistent element is linked to a given state symbol and additionally what the current state of the linked persistent element is. For example, the state symbols 318, 320, 322 each depict the avatar of the corresponding persistent element 312, 314, 316 with the current state indicated by the fill pattern. In other embodiments, other suitable visual presentations and animations may be used to visually link each persistent element to any corresponding state symbol.

The state symbols 318, 320, 322 are configured to be dynamically updated in response to changes to the state of the persistent elements 312, 314, 316. That is, as the state of the persistent element changes, any corresponding state symbols are also animated to reflect the change in state. In some embodiments, the animation sequence for presenting a change in state may appear to originate from the state symbols rather than the persistent elements. Other suitable animations and updated presentations may be used to reflect the linked changes between the persistent elements and the state symbols, including changing the appearance of the state symbols during the next spinning and stopping animation (i.e., for the next game outcome).

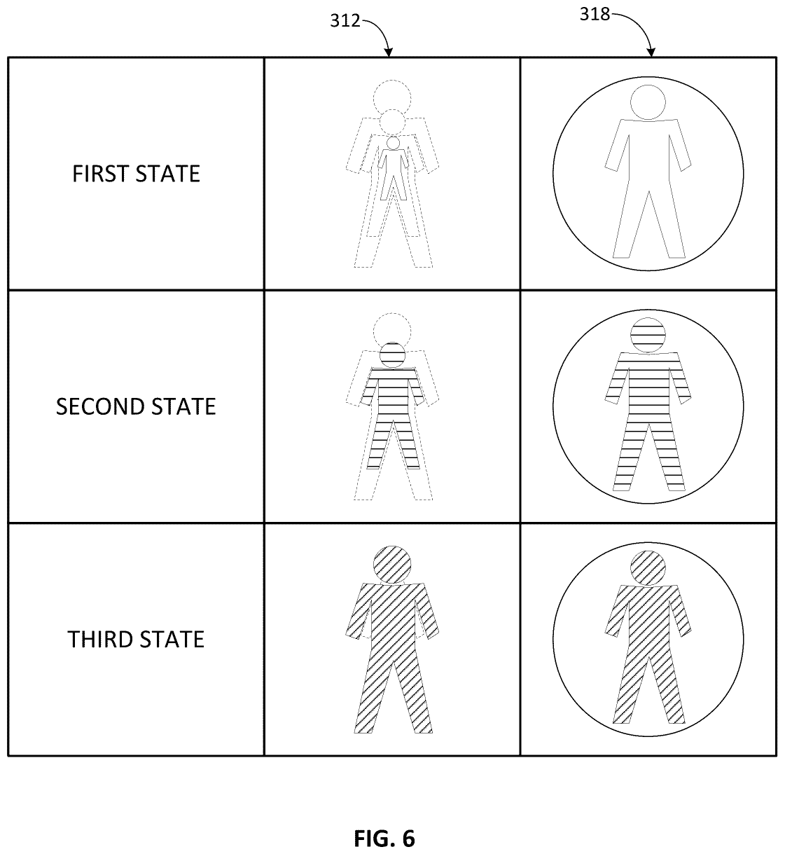

FIG. 6 depicts a set of example states for the first persistent element 312 and the first state symbol 318. More specifically, in the example embodiment with three states, the persistent element 312 and the state symbol 318 are configured to have an aligned or linked presentation to reflect the current state of the first persistent element 312 through matching fill patterns. In certain embodiments, the size of the avatar on the state symbol 318 may be changed to reflect the relative size of the first persistent element 312.

It is to be understood that the state configuration and the corresponding presentations of the persistent element states shown in FIGS. 5 and 6 are for exemplary purposes only to illustrate the relative relationships between different game presentation elements and are not intended to limit visual presentations and animations to specific embodiment shown in FIGS. 5 and 6. For example, the persistent elements 312, 314, 316 (and, by extension, the state symbols 318, 320, 322) may be themed to be different monsters, robots, and/or other characters that have clear visual distinctions between each other and each respective state, such as a monster that “evolves” between states to gain new visual features as the monster progresses towards a final or maximum state.

Each persistent element 312, 314, 316 is associated with a game enhancement based on the current state of the element 312, 314, 316. As used herein, a “game enhancement” may include awards, modifiers, additional or alternative symbols and/or symbol positions, a bonus game feature, and the like. The game enhancement is applied to one or more game outcomes in response to a trigger event associated with the respective persistent element. In some embodiments, the trigger event is limited to a bonus game. The trigger event includes one or more game events and/or conditions detectable within one or more game outcomes. In the example embodiment, the trigger event includes the presence of one or more state symbols within a game outcome. In other embodiments, additional or alternative events or conditions are considered to determine whether or not a trigger event is active, such as detecting state symbols over a plurality of game outcomes.

In at least some embodiments, the game enhancement changes based on the current state of the persistent element. For persistent elements with an ordered progression through the states, the game enhancement may increase, include additional enhancements, increase the probability of another game vent, or provide some other additional benefit (or potential benefit). For example, if the game enhancement is a multiplier appliable to one or more values or awards within the game, the multiplier may be 2× for the first state, 3× for the second state, and 4× for the third state. In another example, a number of wild, value-bearing, and/or other suitable special symbols may be added to one or more game outcomes, where the number of added symbols increases as the persistent element progresses from the first to the third state.

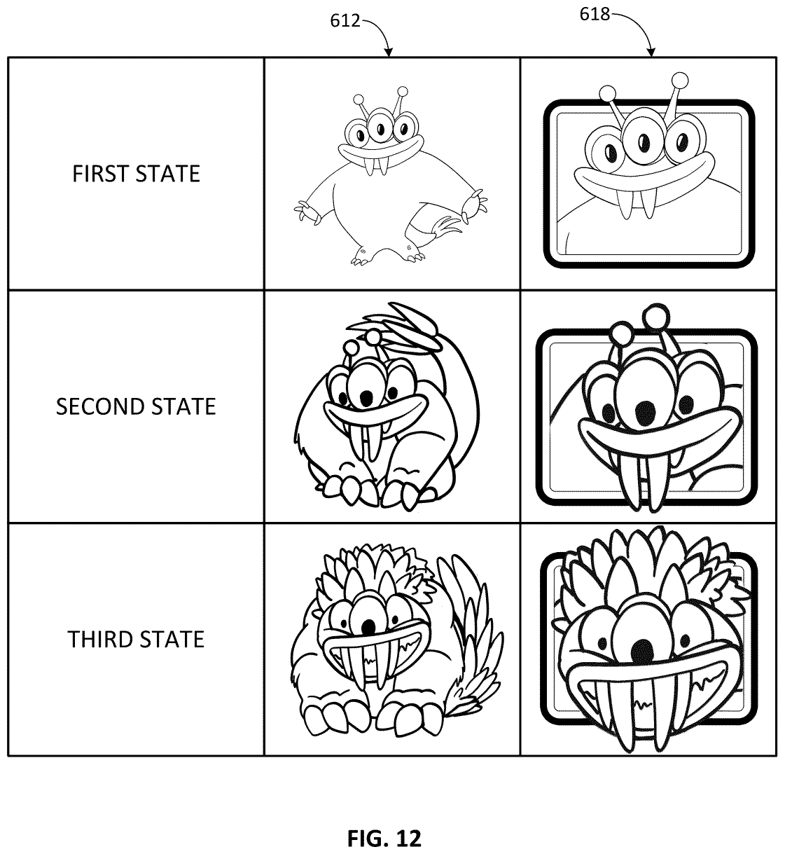

FIG. 12 depicts another example persistent element 612 and linked state symbol 614 through a plurality of different states. More specifically, the persistent element 612 and state symbol 614 depict a monster avatar that has three visually distinct states or evolutions represented by different visual characteristics of the monster avatar. As the monster evolves, the corresponding symbols change, and the game enhancement associated with the persistent element 612 changes.

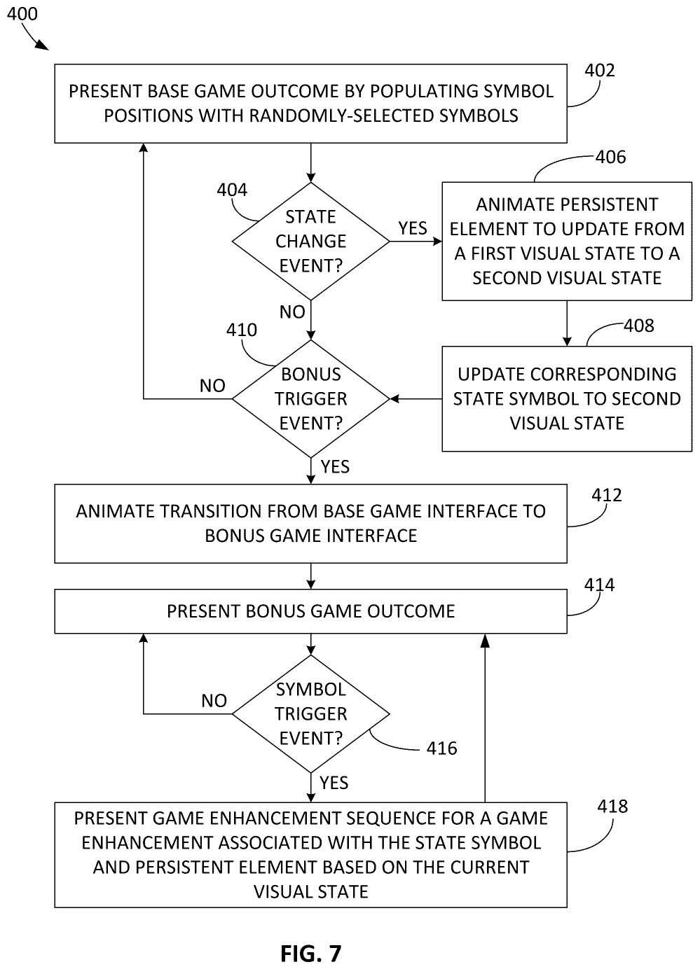

FIG. 7 depicts a flow diagram of an exemplary method 400 for operating a gaming machine of a gaming system (e.g., the system shown in FIGS. 1 and 2). The method 400 is performed using game-logic circuitry (which may be separate from, partially integrated with, or wholly integrated with the gaming machine) of the gaming system and a presentation assembly of the gaming machine. In other embodiments, the method 400 includes additional, fewer, or alternative steps and/or is performed using a different configuration of devices, including those steps and devices described elsewhere herein.

The method 400 is associated with a game presented by the gaming machine. The game includes a base game and a bonus game, where the bonus game is selectively initiated in response to one or more events and/or conditions detected within the base game. Both the base and bonus games include a plurality of symbol positions, which may be arranged into one or more symbol arrays. The symbol positions are associated with one or more sets of available symbols (e.g., a symbol-bearing reel strip) to randomly populate the symbol positions with symbols from the associated sets of available symbols as described herein.

In the example embodiment, the method 400 is further associated with a gaming session established at the gaming machine by a player to play the game. The player initiates the gaming sessions through providing player input at the gaming machine, such as providing a credit input, provide player identification information (e.g., a player account number), or opening an application associated with the game. For credit-wagering embodiments, the player provides a credit input to establish a credit balance. The credit input may be one or more physical items associated with a credit value, such as bills, coins, cards, tickets, and the like, at a corresponding credit input device. The credit input may instead be provided through a digital means, such as linking a digital wallet or account having a pre-established credit balance to the gaming session. The credit balance is presented to the player through one or more interfaces of the presentation assembly to enable the player to monitor the current state of the credit balance while playing the game. In other embodiments, the game is a non-wagering game, and the credit balance may be established without funding from an external credit input or may apply the credit input in another form. For example, credit inputs may be used to establish and/or extend the duration of the gaming session.

Upon establishing a credit balance, the gaming session is activated, and the base game is presented by the presentation assembly via a base game interface. As used herein, the “game interfaces” include one or more visual output devices of the presentation assembly for visually conveying gameplay of the game and any associated information, presentation elements, animations, and the like. In one example, the game interface is presentable within a single display device of the presentation assembly. In another example, an electronic display device is paired with a set of mechanical reels for the game interface. In a further example, the game interface is presented across a plurality of electronic displays, which may include one or more display devices arranged separate from the other display devices on the gaming machine.

Presenting the base game interface includes presenting game and presentation elements of the base game. For example, the plurality of symbol positions is shown for subsequent game outcomes. In the example embodiment, the base game interface includes at least one persistent element at least partially external to the symbol positions. The persistent elements may be avatars, characters, and/or other suitable presentation elements that can be integrated within the game interface. The persistent elements may have a visual theme consistent with the game of the gaming session. For example, each persistent element may be a different monster that can “evolve” within play of the game as described herein.

The persistent elements may include functionality similar to the coin pots 212, 214, 216 shown in FIG. 4. That is, the persistent elements include “perceived persistence” functionality and are linked to one or more symbols available to populate the symbol positions to trigger or otherwise facilitate the functions associated with the persistent element. The perceived persistence includes dynamic visual changes and/or animations associated with the persistent element that have no or substantially limited effect on the underlying game function. In other embodiments, the persistent elements do not have a perceived persistence functionality.

Similar to the pots shown in FIG. 4 and the persistent elements shown in FIG. 5, the persistent elements are associated with one or more respective game enhancements or features. The game enhancements provide a benefit or potential benefit relative to gameplay without any active game enhancements. For example, the game enhancement may include a multiplier that is applied to an award value. In another example, the game enhancement includes beneficial changes to the game that increase the chance of collecting an award rather than outright providing or modifying an award, such as providing free spins (i.e., game outcomes), bonus symbols or symbol positions, contributing to a trigger condition, and the like. In at least some embodiments, including the embodiment described herein with respect to the method 400, the game enhancement is selectively activated within the bonus game and may not be available within the base game. In other embodiments, the game enhancement is additionally or alternatively available within the base game. In such embodiments, the trigger condition for applying the game enhancement may differ between the base and bonus games.

Each persistent element has a set of states, where the persistent element can be dynamically changed from one state to another as described herein. In certain embodiments, some persistent elements may have a single state. Each state is associated with a visual presentation of the persistent element such that the player may readily distinguish the persistent element within different states. The states not only affect the visual presentation of the persistent element but may also affect the game enhancement of the persistent element. That is, the game enhancement changes based on the current state of the persistent element. In embodiments in which the states are defined to form a progression path, the game enhancement may improve as the current state progresses to the “end” of the progression path.

In embodiments in which the persistent elements include perceived persistence functionality in combination with the states, the “perceived” presentation (i.e., visual changes without substantially changing underlying gameplay or game parameters) may be integrated between state transitions. For example, the character or avatar of the persistent element may be configured to visually grow or expand between states in response to certain game events, while the character or avatar gains or otherwise changes other visual characteristics to indicate a state change. In other embodiments, the states of the persistent element are fully incorporated within the perceived persistence functionality and do not affect the underlying gameplay or game parameters.

Each persistent symbol is associated with one or more symbols for activating or otherwise applying different functionality of the persistent element as described herein. For example, the persistent element may be associated with a bonus trigger symbol for triggering the bonus game, a state symbol for changing the current state of the persistent element, a game enhancement symbol for applying or triggering a game enhancement, a perceived persistence symbol for changing a visual appearance of the persistent element without affecting the underlying gameplay or game parameters, and/or the like. In some embodiments, one or more symbol types may be configured to provide several of these functions, such as the state symbol described herein with respect to the method 400. In certain embodiments, the functionality of the persistent elements and the associated symbols may be based on additional or alternative parameters or conditions, such as detecting a combination of symbols, the current game feature (i.e., base or bonus game), and the like.

The state symbols are configured to include a dynamic presentation that is linked to the current state of the associated persistent element. That is, the presentation of a given state symbol matches or is otherwise visually paired with the current state of persistent element. For example, if the persistent element includes an avatar or character that changes according to the current state, the state symbol may be configured to include the avatar in its current state or be themed to align with the state of the persistent element in a manner that is readily identifiable by the player.

In the example embodiment, the method 400 begins at step 402, where the game-logic circuitry generates a base game outcome for the base game and causes the presentation assembly to present the base game outcome. More specifically, the base game outcome includes populating the symbol positions with randomly selected symbols from the one or more available sets of symbols based on one or more random determinations by the game-logic circuitry, such as generating one or more random number via a random number generator and comparing the random values to weighted tables including the available symbols or reel stop positions to select the populating symbols. The outcome presentation includes one or more animations and/or other changes to the base game interface to visually indicate to the player that a base game outcome has been determined. For example, any symbol-bearing reel strips may be animated to spin and stop at the symbols forming the base game outcome. Other suitable animations may be used based on the specific configuration and/or theme of the base game interface. In at least some embodiments, the step 402 is performed in response to player input. The player input may initiate a wager, which is decremented from the credit balance of the gaming session. In non-wagering embodiments, the player input may or may not be tied to a non-credit balance (e.g., a number of spins).

The game-logic circuitry is configured to perform one or more outcome determinations for each base game outcome. An outcome determination is a set of instructions or parameters defining a particular game event or game condition and is associated with one or more automated actions responsive to the presence or absence of the defined game event or condition. For example, the game-logic circuitry compares the symbols of the base game outcome to one or more predefined award criteria to determine if any winning symbol or combination of symbols is present within the outcome.

Two example outcome determinations are described herein at steps 404 and 410. It is to be understood that although the method 400 depicts two outcome determinations, other suitable outcome determinations may be performed for each base game outcome. The outcome determinations may be performed sequentially, in parallel, or in another suitable processing order. For example, some outcome determinations may be performed in a specific order to ensure an action of a preceding determination is applied prior to analyzing a subsequent outcome determination, while other outcome determinations may be processed according to underlying resources of the game-logic circuitry because said determinations are not reliant upon the result of other outcome determinations.

At step 404, the game-logic circuitry is configured to determine whether or not a state change event is present within the base game outcome. In the example embodiment, the state change event is a two-step event based on the presence of one or more state symbols within the game outcome and a random determination in response to detecting the state symbol. That is, a state change event is not guaranteed for a game outcome including the required number of state symbols. In some embodiments, the state change event is based on a static probability irrespective of the number of state symbols and/or other conditions of the base game. In other embodiments, the probability of triggering a state change event is dynamic and may be adjusted based on one or more factors, such as the number of state symbols, the wager amount or frequency, and the like.

In the example embodiment, the association between the state change event and one or more of the persistent elements is based on the state symbols forming the state change event. In other embodiments, the state symbols may not be associated with a single persistent element but rather are associated with all or a plurality of the persistent elements. In such embodiments, the state change event may be triggered for all of the associated persistent elements, or the state change event determination at step 404 may include a selection of one or more of the associated persistent elements, where the following actions or steps of the state change event are only applied to the selected persistent elements.

If the state change event is determined to be active, the game-logic circuitry causes the presentation assembly to present a state change sequence via steps 406 and 408. The state change sequence is a set of animations and other changes to the game interface to visually convey the action or actions taken in response to the state change event. In the example embodiment, the presentation assembly is configured to animate the persistent element associated with the state change event to update from a prior visual state to a new visual state at the step 406. In at least some embodiments, the gaming session is initiated with all of the persistent elements in a first or initial state. In other embodiments, one or more persistent elements may be initiated at a different state. In the example embodiment, the persistent element is initiated in a first visual state and is updated to a second visual state according to a predefined progression of states (i.e., from the first state to the second state, from the second state to the third state, etc.). In addition to the visual changes to the persistent element, one or more underlying parameters or variables are updated to reflect the change in the persistent element state, such as parameters defining the game enhancement of the persistent element.

In response to changing the state of the persistent element, the game-logic circuitry causes the presentation assembly to update any corresponding state symbols to align with the new current state of the persistent element at step 408. In one example, the persistent element was initialized in a first visual state, and the associated state symbols are initially presented with a first visual state linked to the state of the persistent element. In response to the persistent element being updated to the second visual state at the step 406, the associated state symbols are updated to a corresponding state visual state. The visual states of the persistent element and any associated state symbols may match, include the same or similar presentation elements, and/or are otherwise visually presented in a manner that a player can readily identify which persistent element is associated with a particular state symbol and distinguish between different states of the persistent element.

In certain embodiments, in addition to the steps 406, 408, the state change event may cause one or more game actions (i.e., actions that affect the underlying game beyond the presentation) within the base game outcome and/or other subsequent game outcomes. For example, the game enhancement of the persistent element may be applied to one or more game outcomes in response to the state change event.

Following the steps 406, 408 or in response to determining a state change event is not active at the step 404, the game-logic circuitry determines at step 410 whether or not the base game outcome includes a bonus trigger event. The bonus trigger event is a game event that can result in initiating the bonus game feature. The bonus trigger event may rely upon one or more game parameters and/or conditions. That is, the game-logic circuitry stores predefined criteria for the bonus trigger event, and the game-logic circuitry compares the current state of the base game to the predefined criteria to perform the determination at the step 410. For example, the bonus trigger event includes detecting one or more bonus trigger symbols within the base game outcome. The bonus trigger symbols may be dedicated to the bonus trigger event or include other functionality, such as for determining winning symbol combinations. In the example embodiment, the state symbols also operate as bonus trigger symbols. In other embodiments, additional or alternative game parameters and/or conditions define whether or not a bonus trigger event has occurred, including game parameters and/or conditions over a plurality of game outcomes.

In some embodiments, the bonus trigger event is further based on one or more random values or other random determinations beyond the random determinations for generating the base game outcome. In the example embodiment in which the state symbols also act as bonus trigger symbols, a random value or other variable is generated to determine whether or not the bonus trigger event is active in response to detecting the presence of the state symbol within the game outcome. In some embodiments, the determinations at steps 404, 410 have separate random determinations (i.e., the determination at step 404 has no effect on the determination at step 410, and vice versa). In such embodiments, the random values or variables generated by the game-logic circuitry may be shared between the determinations 404, 410 with different predefined criteria to reduce the computing resource burden of the outcome determinations. In other embodiments, the random determinations at steps 404, 410 are combined. For example, a single random determination (or a single set of random determinations) is performed in response to detecting one or more state symbol, where the random determination results in a state trigger event, a bonus trigger event, another suitable event (e.g., a perceived persistence sequence where the persistent element visually changes), combinations thereof, or no event.

If bonus trigger event is determined at step 410 to be inactive, through random determination and/or the absence of the criteria defining the bonus trigger event, the base game continues with a subsequent base game outcome at step 402. Prior to the subsequent base game outcome, the game-logic circuitry performs and completes any remaining outcome determinations and causes the presentation assembly to present any corresponding presentation sequences. For example, if a winning combination of symbols is identified in the base game outcome, an award sequence is presented to provide an award associated with the winning combination. In addition to animations that highlight or otherwise visually convey the winning combination to the player, the award sequence includes animations or updates to a meter or other presentation element associated with the credit balance, where the credit balance is updated to include the award. The base game continues through steps 402-410 of the base game until the gaming session is completed (e.g., the player initiates a cashout sequence) or until a bonus trigger event is detected and determined to be active.

In response to determining a bonus trigger event to be active, the game transitions from the base game to the bonus game. More specifically, the game-logic circuitry causes the presentation assembly to animate a transition from the base game interface to a bonus game interface at step 412. The animations may include adding, removing, or altering the presentation and game elements displayed by the presentation assembly to facilitate the functions of the bonus game, particularly the functions that differ from the base game. The bonus game interface may include one or more elements that are the same as within the base game interface, such as the symbol positions. The sets of available symbols and/or the corresponding probabilities and awards may be changed for the bonus game.

In the example embodiment, each bonus game instance is associated with at least one persistent element such that the bonus game functions of the persistent element as described herein are only available for the associated or “active” persistent elements. A bonus game instance may be associated with one or more persistent elements. In certain embodiments, the active persistent elements may be limited to a single element per bonus game instance. The “inactive” or unassociated persistent elements may not be included within the bonus game instance, or the inactive persistent elements may need to be activated through one or more game events within the bonus game to be included. The active and inactive persistent elements may be visually distinguished within the bonus game interface, where visual emphasis (e.g., highlighting, centrally aligned within the interface, scale increased, animated, colored, etc.) is provided to the active persistent elements while the inactive persistent elements are presented in a relatively diminished visual state or otherwise removed from the bonus game interface. In certain embodiments, the persistent elements may not be associated with at least some bonus game instances.

To determine which persistent element is active for a given bonus game instance, the game-logic circuitry may incorporate game history, random chance, player input, and the like into a persistent element selection process within the initiation of the bonus game instance. In some embodiments, the active persistent elements are selected based on which persistent elements are associated with the active bonus trigger event. For example, in embodiments in which the bonus trigger event includes bonus trigger symbols, the active persistent elements are associated with the bonus trigger symbols forming the bonus trigger event. Additionally or alternatively, a random determination by the game-logic circuitry may select a persistent element to be active in a bonus game instance. In one example, in addition to the state symbols associated with the persistent elements, another bonus trigger symbol is available within the base game and is not associated with any persistent element. If the bonus trigger event is determined to be active based on this trigger symbol, the game-logic circuitry randomly selects one or more persistent elements to activate for the bonus game instance.

Activating a persistent element for a bonus game instance provides one or more bonus game functions associated with the active persistent element to the bonus game instance. For example, each persistent element may be associated with specific game mechanics, such as expanding the symbol positions, holding or locking symbols within the symbol positions, picking awards from an award wheel or prize board, and the like, which may not otherwise be available within the bonus game. Additionally or alternatively, each persistent element is associated with a game enhancement that changes based on the current state of the persistent element. The game enhancement may be associated with a new game mechanic, an existing game mechanic, an award, and/or other suitable means of enhancing the game feature. The game enhancement and other bonus game functions are limited to active persistent elements, where the bonus game functions associated with any inactive persistent elements are not available within a given bonus game instance.

In some embodiments, the active and inactive persistent elements do not change after a bonus game instance is initiated. In other embodiments, the persistent elements may be selectively updated to be active or inactive in response to game events and/or conditions within a bonus game instance, thereby enabling a dynamic bonus game feature. In one example in which the active persistent elements are based on the symbols within the bonus trigger event, the symbols associated with the inactive persistent elements may continue to be available within the bonus game to provide an opportunity to trigger an activation event for an inactive persistent element.

In some embodiments, each active persistent elements (and inactive persistent elements for embodiments in which inactive persistent elements may be activated within the bonus game) maintain their respective current state from the base game into the bonus game. The state of the active persistent elements may be changed within play of the bonus game or remain static. That is, in certain embodiments, one or more state change events may be available within the bonus game to change the current state of one or more persistent elements. In one or more embodiments, the state of the active persistent elements may change during the transition to the bonus game. In one example, the game-logic circuitry stores a weighted table or other weighted data structure to compare with a random value or other random determination at the transition to the bonus game to determine if any persistent elements should change state.

At step 414, the game-logic circuitry generates a bonus game outcome and causes the presentation assembly to the present the bonus game outcome. The bonus game outcome includes populating the symbol positions of the bonus game interface with randomly selected symbols selected from one or more bonus sets of available symbols (which may be the same or different from the sets of available symbols from the base game). In other embodiments, additional or alternative game elements are incorporated into the bonus game outcome, such as a segmented wheel of symbols or other selectable segments. Similar to the base game outcome, the game-logic circuitry is configured to perform one or more outcome determinations based on the bonus game outcome, such as identifying any winning symbol combinations.

Another outcome determination by the game-logic circuitry is depicted at step 416. More specifically, the game-logic circuitry determines whether or not a symbol trigger event has occurred based on the bonus game outcome. The symbol trigger event is a game event and/or game condition associated with one or more game enhancements of the active persistent elements as described herein. The symbol trigger event is associated with at least one active persistent element of the bonus game instance. The association between the symbol trigger event and the at least one active persistent element may be determined randomly and/or based on the underlying gam elements of the symbol trigger event. In the example embodiment, the symbol trigger event includes detecting one or more state symbols within the bonus game outcome. The active persistent elements associated with the state symbols are, by extension, associated with the symbol trigger event. If the symbol trigger event is not associated with one or more active persistent elements prior to the determination at step 416, the game-logic circuitry is configured to select one or more active persistent elements to be associated with the particular trigger event.

In other embodiments, the symbol trigger event may include additional or alternative criteria for the game-logic circuitry to determine whether or not the symbol trigger event has occurred, including criteria over a plurality of bonus game outcomes. In one example, similar to the determinations at steps 404 and 410 of the base game, the symbol trigger event may also include a random element, where a random determination is performed in response to detecting the threshold number of state symbols within the bonus game outcome. Although the game event is described herein as the “symbol trigger event,” it is to be understood that this event may include trigger criteria that does not include detecting the presence or absence of certain symbols or combinations of symbols. For example, the bonus game in some embodiments may include a segmented wheel in combination with the symbol positions, where the wheel is spun and stopped to determine whether or not the game event at step 416 has occurred.

If the game-logic circuitry determines that the symbol trigger event did not occur, the game-logic circuitry completes any remaining outcome determinations according to the specific configuration of the bonus game before continuing the bonus game. The bonus game continues with the conclusion of the bonus game or a subsequent bonus game outcome at step 414. The bonus game has a limited duration, which may be defined through a period of time, a number of game events (e.g., spins or game outcomes, a number of non-winning outcomes, etc.), a resource balance (e.g., a bonus credit balance), and the like. The bonus game is configured to continue until the end of the bonus game duration. At the end of the duration, the game-logic circuitry and the presentation assembly are configured to transition back to the base game (or another suitable game feature) by transitioning from the bonus game interface back to the base game interface.

If, however, the game-logic circuitry determines at step 416 that a symbol trigger event has occurred, the game-logic circuitry causes the presentation assembly to present a game enhancement sequence to apply a game enhancement to one or more outcomes of the bonus game at step 418. More particularly, the symbol trigger event is associated with at least one active persistent element, and the game enhancements of the associated persistent elements are applied to the bonus game at step 418. The game-logic circuitry may be configured to apply all, a threshold number, a subset, or one game enhancement from the available game enhancements of the active persistent elements associated with the symbol trigger event. In certain embodiments, some game enhancements are selectively available based on the game elements forming the bonus game outcome. For example, if one game enhancement increases the value presented on one or more value-bearing symbols, the game enhancement may not be available for outcomes lacking any value-bearing symbols.

The game enhancement and the game enhancement sequence may be applied for the current bonus game outcome and/or subsequent bonus game outcomes. The application may be integrated with other outcome determinations, such as determining winning symbol combinations, or independent, such as a credit award applied to the credit balance of the player irrespective of the symbols forming the bonus game outcome. For game enhancements persisting over a plurality of game outcomes, the presentation assembly may be configured to visually convey the duration of the enhancement and/or divide the game enhancement sequence for the different game outcomes.

In the example embodiment, the state symbols associated with the symbol trigger event are incorporated within at least some game enhancement sequences. For example, the game enhancement may be applied to a portion of the symbol positions based on a positional relationship with the symbol positions occupied by the state symbols (e.g., the game enhancement is applied to rows or columns including the state symbols or is applied to symbol positions adjacent to a position occupied by a given state symbol). Some game enhancements are applied irrespective of the location of the state symbols within the symbol positions, while the game enhancement sequence still includes animations and/or other presentations updates incorporating the state symbols to visually convey to the player which symbols are associated with the symbol trigger event and/or what game enhancement is being applied.

The game enhancement selected for the game enhancement sequence at step 418 is not just based on the associated persistent element, but also the current state of the persistent element and the state symbol. In the example embodiment with a progression path through the states, increasing the state or level of the persistent element also increases the benefit or potential benefit of the game enhancement. For example, a game enhancement that awards additional free bonus game spins may award one free spin at a first state of a persistent element, three at a second state, and five at a third state.

Examples of the game enhancement sequence are provided herein. A first example game enhancement sequence includes replacing one or more symbols within a bonus game outcome with value-bearing symbols having award indicia visually indicating a corresponding award value. The award values of the value-bearing symbols may be automatically awarded in response to the presence of the value-bearing symbols within the symbol positions or the award values may be awarded in response to a particular game event and/or condition the game-logic circuitry is configured to detect from the bonus game outcomes (e.g., detecting a threshold number of value-bearing symbols in an outcome or detecting a catalyst symbol within the outcome). The first example game enhancement sequence varies based at least partially on the state of the corresponding persistent element. For example, the number of symbols replaced may increase as the state of the persistent element increases, or the award values of the value-bearing symbols are selected from a set of values having an increased value (including progressive jackpot awards) relative to the set of values from a prior state. The value-bearing symbols may be awarded and removed within the same game outcome as the symbol trigger event, or the value-bearing symbols may be held within the symbol positions for one or more subsequent game outcomes (e.g., until the conclusion of the bonus game).

The game-logic circuitry is configured to identify which symbols to replace at least partially on the trigger event and/or any other events occurring within the bonus game. In one example, the symbols selected for replacement are based on the relative position of the state symbol of the trigger event. In another example, the game-logic circuitry identifies certain symbols as ineligible for replacement, such as any symbols defining a winning symbol combination, thereby preventing the symbol replacement from eliminating or reducing the win of the player.

The first example game enhancement sequence includes one or more suitable animations to visually indicate the changes to the player. For example, the persistent element associated with the sequence and/or the corresponding state symbols may be animated to change the symbols to value-bearing symbols.

A second game enhancement sequence may include visually designating a subset of symbol positions as a “trigger position subset” or a “trigger region,” where the trigger region is configured to persist for at least one subsequent game outcome for a secondary trigger event. If a value-bearing symbol or other predefined symbol occupies the trigger region, the trigger region is automatically filled with value-bearing symbols and/or other suitable symbols according to the specific bonus game configuration. In one example, the trigger region includes a column of a symbol array, and landing one value-bearing symbol within the column of the trigger region causes the remaining positions of the column to be populated by value-bearing symbols. The state of the persistent element may affect the value of value-bearing symbols (and/or other suitable symbols) populating the remaining positions, increase the positions within the trigger region (e.g., from one column to two columns), increase the number of trigger regions, and/or increase the duration of the trigger region. The trigger region may be randomly generated or based on the trigger event, such as based on the position of the state symbol within the symbol positions. In certain embodiments, the player may be prompted to select from a set of available trigger regions to be applied for one or more spins.

A third game enhancement sequence may include applying a multiplier to one or more values within the bonus game. In one example, the multiplier is applied to one or more value-bearing symbols to increase the respective award values. In another example, the multiplier is applied to the next awarded value to the player, such as a value provided in response to detecting a winning symbol combination within the bonus game. The multiplier may be applied to value that is designated to be awarded to the player (i.e., the multiplied award is guaranteed to be provided to the player), or the multiplier is applied to a value that is awarded through a subsequent game event and/or condition. For example, value-bearing symbols may be held within the symbol positions for one or more bonus game outcomes and are only awarded in response to a particular game event, such as reaching or exceeding a threshold number of held symbols and/or detecting a catalyst symbol within the symbol positions. If said event does not occur before the conclusion of the bonus game, the multiplied value-bearing symbols are removed without being awarded. Other suitable variations of the multiplier application are contemplated according to the particular configuration of the underlying bonus game. In certain embodiments, rather than applying the multiplier to a symbol or award, the multiplier is applied to a symbol position to be applied to any occupying symbol or a subsequent symbol occupying the multiplied symbol position.

The state of the persistent element may, for the third example game enhancement sequence, vary the multiplier and/or the number of symbols or symbol positions. For example, the multiplier value may increase as the state of the persistent element increases. In another example, the multiplier is applied to up to three symbols in a first state, up to five symbols in a second state, and up to nine symbols in a third state. In certain embodiments, the selection of which symbols to be modified by the multipliers may be based on the state symbols forming the symbol trigger event, such as the relative position of the state symbols.

A fourth example game enhancement sequence includes holding value-bearing symbols within the symbol positions for one or more additional game outcomes, where the award value of any value-bearing symbols for a given bonus game outcome are awarded, thereby causing the award values of the held value-bearing symbols to be awarded a plurality of outcomes. It is to be understood that, although the example provided herein refers only to value-bearing symbols, the game enhancement may be applied to other suitable symbols and/or other game elements. For example, certain bonus symbols may provide non-value awards, such as additional spins, multipliers, symbol enhancements, wild symbol stacks (to replace symbols at one or more positions), and the like. In some embodiments, if the bonus game concludes prior to the held duration of a symbol expires, the award associated with the held symbol may be provided a number of times matching the remaining duration.

The state of the persistent element may affect the number of held symbols and/or the duration of the held symbols. In one example, the value-bearing symbols are held one, two, or three subsequent game outcomes for the first, second, and third states of the persistent element, respectively. In certain embodiments, symbols are selected to be held based on random selection and/or the relative position of the state symbols forming the trigger event. The held symbols may be visually distinct from the other symbols and/or the act of holding or locking the symbols into the symbol positions may be visually conveyed to the player through one or more suitable animations and/or visual updates to the game interface.

Other suitable game enhancements adapted to various game configurations and themes are contemplated within the spirit and scope of the present disclosure, including those described elsewhere herein. For example, and without limitation, the game enhancement may include non-multiplier modifiers, credit awards, additional free spins or outcomes, enhanced symbols added to the set or sets of available symbols, adding symbol positions (e.g., symbol array expansion), prize board selections, award wheel spins, and the like. Similarly, variations of such game enhancements based on the state of the corresponding persistent elements are readily contemplated by the present disclosure, generally through changing one or more quantifiable values of the game enhancement. In certain embodiments, some variations are not quantifiable changes, but rather are expressed through other perceivable means (e.g., changes in visual theme or appearance).

In bonus game instances with multiple active persistent elements, multiple game enhancements may be concurrently applied. In such embodiments, the game-logic circuitry may be configured to apply the enhancements according to a predefined hierarchy or order of operations to facilitate certain interactions between the enhancements. For example, game enhancements that add value-bearing symbols or other suitable game elements may be applied prior to game enhancements that modify symbols and/or other game elements within the game interface, thereby increasing the potential value of the newly added game elements. In other embodiments, each game outcome may include or initiate one game enhancement per outcome.

Following the sequence at step 418, the game-logic circuitry performs any remaining outcome determinations and any corresponding actions for the bonus game outcome of the step 414. After the outcome determinations are completed, the method 400 returns to the step 414 for a subsequent bonus game outcome or concludes the bonus game instance. That is, the outcome determinations may include a duration determination, where the game-logic circuitry monitors one or more variables indicating any remaining duration of the bonus game instance. For example, a counter variable may be used to monitor a number of outcomes defining the duration of the bonus game instance or a timer variable monitors a period of time defining the duration. If these variables reach a conclusion threshold, the duration of the bonus game instance has expired, and the bonus game is concluded. Concluding the bonus game includes a transition sequence in which the game interface transitions from the bonus game interface to the base game interface or the interface for another suitable game aspect of the gaming session. In certain embodiments, the transition sequence includes an award sequence at the end of the bonus game to visually indicate one or more awards from the bonus game to the player.

In the example embodiment with a progression of states or evolutions for each persistent element, the conclusion of the bonus game causes at least the active persistent elements to be reset to a different state, such as an initial state or another suitable reset state. The inactive persistent elements may remain in the same state from the transition from the base game to the bonus game at the step 412, or the inactive persistent elements may also reset. In some embodiments, additional or alternative reset conditions or reset events may be available to reset the state of a given persistent element. In one example, the state of a persistent element may reset or “regress” in response to the absence of a corresponding state symbol within a limited duration, where the duration resets in response to detecting the state symbol in a game outcome. For regression, the persistent element may progress to the last state prior to the current state and progress towards the initial state. In another example, the base game may include a means for automatically applying the game enhancement of the persistent element to the base game instead of the bonus game (e.g., a random chance or a particular combination of symbols) such that the persistent element is reset in response to the game enhancement being applied to the base game. In a further example, a reset symbol may be included within the sets of available symbols.

In some embodiments, the game associated with the method 400 includes more available persistent elements than those present within the game interface at a given time. In such embodiments, the persistent elements provided within the game interface may be selected from the available persistent elements, thereby creating additional variation within different gaming sessions of the same game. The persistent element selection may be random, predefined, based on variable inputs (e.g., game events, player input, etc.), or combinations thereof. In one example, the player is provided an option to choose which persistent elements are selected, thereby enabling the player to choose according to his or her preference is game enhancement or visual appearance. In another example, the base and/or bonus games may include swap symbols that swap one persistent element for another. In a further example, persistent elements may be “unlocked” for selection through game events, player account history, wager history, and the like. The persistent elements initially included at the beginning of a gaming session may be predefined or randomly determined.

Selected persistent elements may be initiated at an initial state or, for persistent elements replacing other elements within a gaming session, the selected persistent elements may inherit the state of the replaced persistent element. In some embodiments, the number of persistent elements included within the game may be variable. That is, in one example, the game may be conducted with one, two, three, or more persistent elements. The number of included persistent elements may vary based on game events and/or conditions, player input (e.g., the player may select a level of volatility through the number of persistent elements, or the player can tailor the number to his or her personal preference).

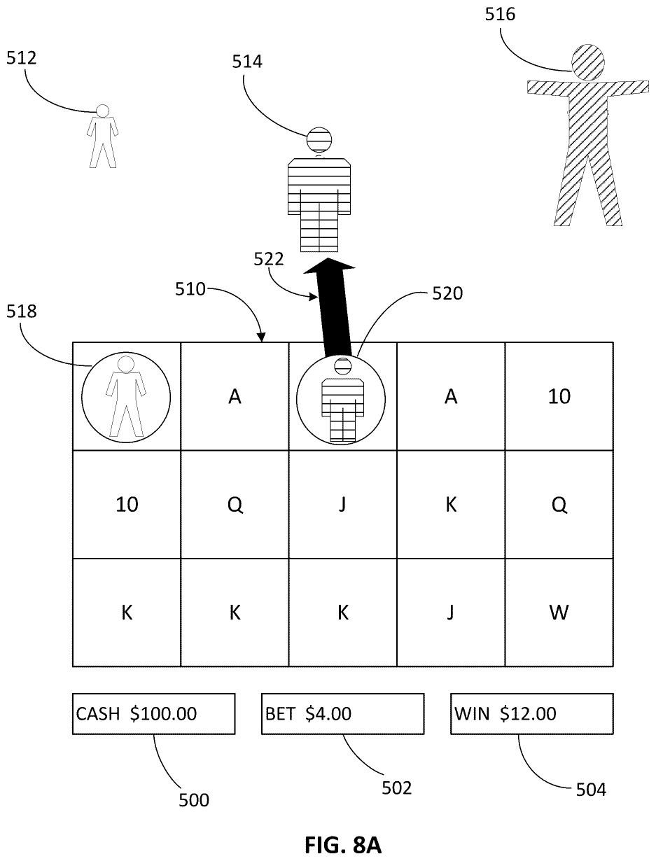

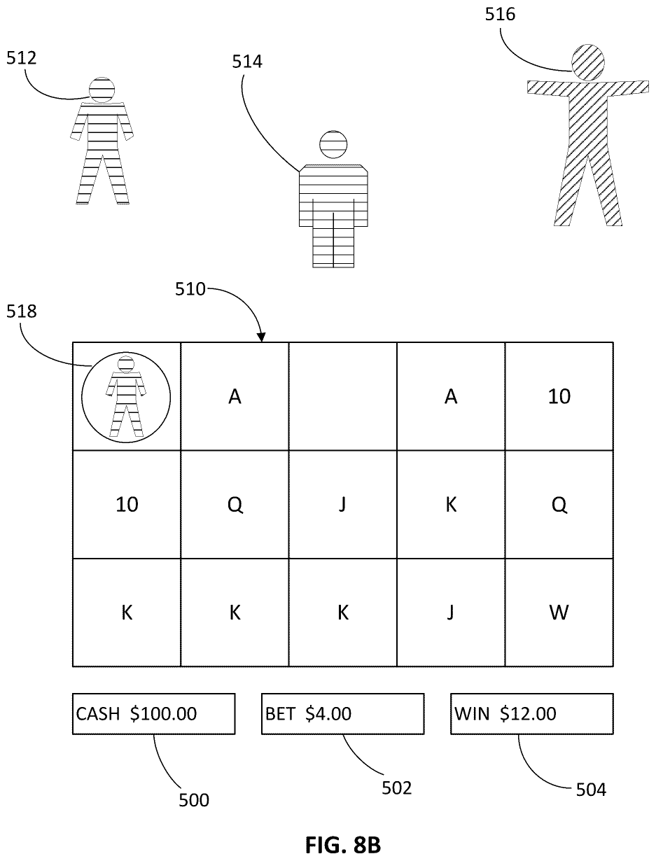

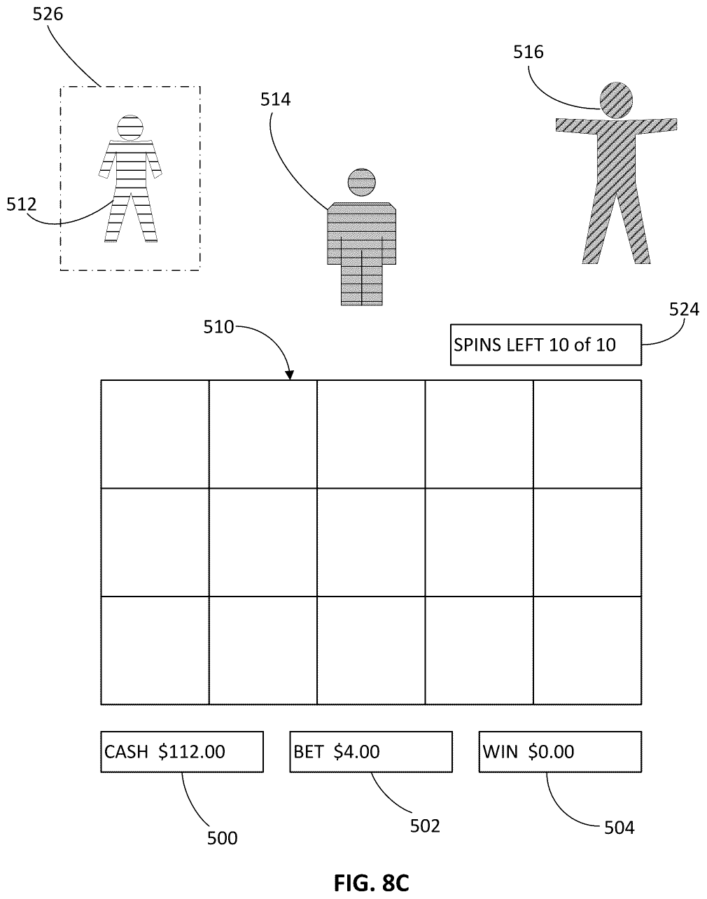

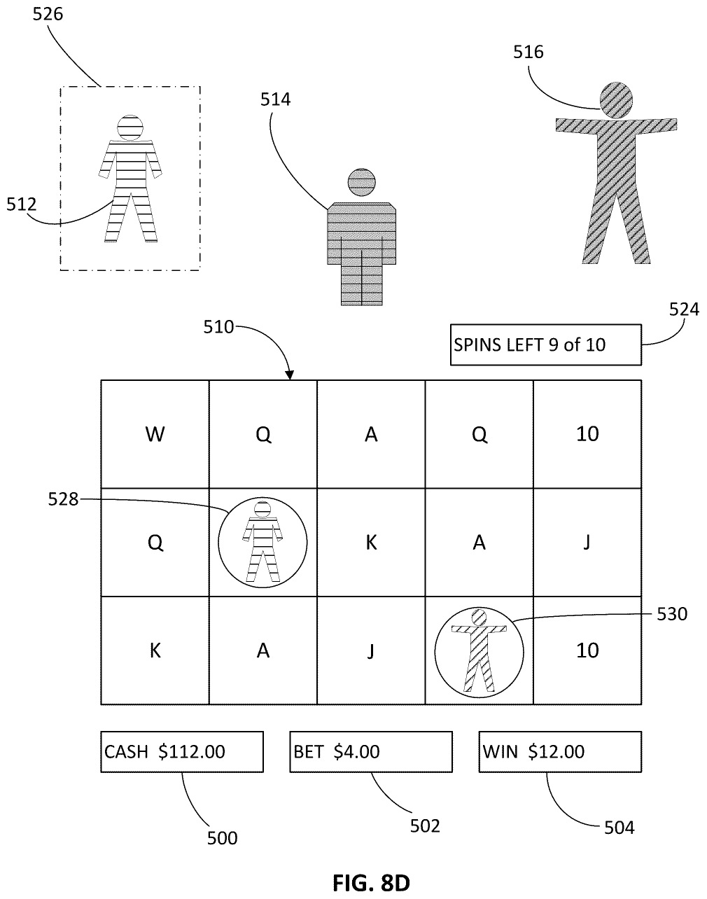

FIGS. 8A-8D depict an example game interface presented by a gaming system (e.g., the system shown in FIGS. 1 and 2) for a game with state-based persistence according to one or more embodiments of the present disclosure. The game interface is presented via a presentation assembly of a gaming machine within the gaming system. The functionality described herein with respect to the game interface is facilitated via the presentation assembly and computer-readable instructions executed by game-logic circuitry of the gaming system (e.g., the circuitry 40 shown in FIG. 2). In the illustrated embodiment, the interface is similar to the game interfaces shown in FIGS. 4 and 5. More specifically, the game interface includes a credit meter 500, a bet meter 502, a win meter 504, a symbol array 510, and a plurality of persistent elements 512, 514, 516 external of the symbol array 510. In other embodiments, the game interface may include additional, fewer, or alternative game and/or presentation elements, including elements described elsewhere herein.

FIG. 8A depicts the game interface as a base game interface for playing a base game. The base game is included within an example wagering game with a bonus game that is triggered from play of the base game as described herein. Although the embodiments described herein are associated with a wagering game, it is to be understood that the game may be configured for non-wagering embodiments. The wagering game is conducted similar to the embodiments described with respect to FIGS. 3A, 3B, and 7 unless otherwise noted. That is, the persistent elements 512, 514, 516 have a perceived persistence functionality, are associated with state symbols available to populate the symbol array 510, include a respective game enhancement appliable to a bonus game, and have independent states that are selected from respective sets of available states. The depicted states in FIG. 8A are similar to the states shown in FIG. 5, where the first persistent element 512 is in a first state, the second persistent element 514 is in a second state, and the third persistent element 516 is in a third state.

FIG. 8A depicts the base game interface at a base game outcome with a state change event for the first persistent element 512. More specifically, the base game outcome includes populating the symbol array 510 with a plurality of randomly selected symbols as shown. The symbols are populated through one or more suitable animations presented by the presentation assembly to visually convey to a player that a game outcome has been generated. In the illustrated embodiment, the base game outcome includes a first state symbol 518 associated with the first persistent element 512 and a second state symbol 520 associated with the second persistent element 514.

In the example embodiment, the state symbols 518, 520 have a plurality of functions when present within the symbol array 510. The game-logic circuitry is configured to detect the presence of any state symbols within a game outcome and then perform one or more random determinations to selectively activate certain game events associated with the state symbols. For example, the state symbols 518, 520 are configured to facilitate perceived persistence, state changes of the persistent elements, and a bonus game trigger. The game-logic circuitry may perform a collective random determination for all of these functions (e.g., by generating one or a single set of random values or variables for comparison to parameters associated with all of the different functions) or independently determine whether to activate each function in response to detecting the state symbols 518, 520. The function of each state symbol 518, 520 or state symbol type may be independently determined, or the function may be collectively determined for all state symbols present within a game outcome.

In the example embodiment, the first state symbol 518 results in a state change event for the first persistent element 512, and the second state symbol 520 results in a perceived persistence sequence for the second persistent element 514. The presentation assembly is configured to present a state change sequence for the first persistent element 512 in response to the state change event. The state change sequence may include, for example and without limitation, animations suitable for the theme and configuration of the first persistent element 512 to visually update the first persistent element 512 from the first state to a second, visually distinguishable state. In one example in which the persistent element 512 is a creature avatar, the different states are depicted as different evolutions of the creature avatar. In some embodiments, the first state symbol 518 is configured to be visually updated within the state change sequence. In other embodiments, the first state symbol 518 remains the same or is removed from the game interface during the state change sequence. Irrespective of the first state symbol 518, subsequent state symbols associated with the first persistent element 512 include a presentation that is linked to the second state of the persistent element 512.

The perceived persistence sequence of the second state symbol 520 includes one or more animations and/or other visual changes that provide a visual change without changing any underlying game parameters. In the above example with creature avatars, the creature may grow or otherwise be animated without changing the current state. In the example embodiment, the second state symbol 520 is configured to be animated to fly towards the second persistent element during the perceived persistence sequence as indicated by arrow 522. In other embodiments, other suitable animations and/or visual changes are applied within the perceived persistence sequence according to the configuration and theme of the game interface.

In at least some embodiments, the different presentation sequences, such as the state change sequence and the perceived persistence sequence, may be selectively intertwined. That is, the game-logic circuitry is configured to orchestrate one or more aggregate sequences that enable multiple presentation sequences to be presented sequentially, in parallel, partially overlapped, or otherwise in a manner that facilitates an intended presentation of the game to the player.

FIG. 8B depicts the base game interface following the state change sequence and the perceived persistence sequence initiated in FIG. 8A. In the illustrated embodiment, the first persistent element 512 and the first state symbol 518 have been animated to upgrade or evolve to a second state as evidenced by the change in size of the first persistent element 512 and the shading of the element 512 and the state symbol 518. In subsequent game outcomes, any new state symbols associated with the first persistent element 512 are presented in a state similar to the first state symbol 518 until the first persistent element 512 changes from the second state. In certain embodiments, the state change sequence may not include linked or mirrored changes to the first state symbol 518. In such embodiments, the first state symbol 518 may be removed from the base game interface (e.g., the symbol 518 is animated to fly up to and merge with the first persistent element 512) or remain unchanged such that the changes are only applied to subsequent state symbols.

In the example embodiment, the perceived persistence sequence results in the second state symbol 520 being removed from the game interface. The removal may be the result of one or more animations. In other embodiments, the second state symbol 520 remains within the game interface following the perceived persistence sequence. In addition to the removal of the second state symbol 520, the second persistent element 514 has changed in size (i.e., increased in size) in response to the perceived persistence sequence without changing state. The second persistent element 514 remains at the increased size until another perceived persistence sequence, a state change sequence, and/or other suitable event, thereby creating the visual perception of persistence. In other embodiments, additional or alternative visual and/or other presentation changes may be used to provide the perceived persistence functionality.

FIG. 8C depicts the game interface in response to a bonus trigger event occurring within the base game. In one example, the bonus trigger event includes the presence of one or more state symbols within a base game outcome, where the resulting game event associated with the state symbols (e.g., a perceived persistent event, a state change event, a bonus trigger event, etc.) is based on one or more random determinations. In other embodiments, the bonus trigger event includes additional or alternative game events or conditions, such as dedicated trigger symbols landing within the symbol array 510. The bonus trigger event causes the game to transition from the base game to a bonus game instance, and the base game interface is transitioned to a bonus game interface. The bonus game interface may include all, some, or none of the game and/or presentation elements of the base game interface. In the example embodiment, the symbol array 510 remains the same, but the bonus game includes one or more sets of available symbols different from the sets available within the base game. The presentation assembly is configured to present one or more animations and/or other presentation updates within a transition sequence to indicate to the player that the bonus game is initiated.

In at least some embodiments, each bonus game instance is associated with one or more persistent element to provide different bonus game functionality as described herein. The persistent elements associated with the bonus game instance may be randomly determined and/or in response to particular game events and/or conditions. In one example, the bonus game instance is associated with the persistent element or elements associated with the bonus trigger event. In another example, the bonus game instance is associated with any persistent element of a particular state or set of states.

In the example embodiment, the bonus game instance is associated with the first persistent element 512 such that the first persistent element 512 is designated as “active” while the second and third persistent elements 514, 516 are designated as “inactive.” Active persistent elements have additional functionality within the bonus game relative to the inactive persistent elements. In some embodiments, the inactive persistent elements may be inactive for the entirety of the bonus game instance. In other embodiments, the inactive persistent elements may be available to be converted into active persistent elements in response to certain game events and/or conditions occurring within the bonus game instance. In one example, the state symbols of the inactive persistent elements are available to populate the symbol array 510 during the bonus game, which may randomly cause the inactive persistent elements to become active.

The bonus game interface is configured to present the active and inactive persistent elements in a visually distinctive manner relative to each other. In the illustrated embodiment, the active first persistent element 512 is presented within a border 526 while the inactive second and third persistent elements 514, 516 are presented greyed out or dimmed. In other embodiments, other suitable presentations may be used for the active and inactive persistent elements, including presentations in which the inactive persistent elements are hidden from the bonus game interface.

In addition to the changes to the persistent elements 512, 514, 516, the bonus game interface includes a spin counter 524. In the example embodiment, the bonus game instance has a limited duration. The limited duration may be a static, predetermined number of game outcomes (e.g., ten outcomes), a dynamic number of game outcomes, and/or other suitable means of measuring game duration, such as a period of time. In the illustrated embodiment, the bonus game instance is initiated with a duration of ten spins or bonus game outcomes, and the spin counter 524 is configured to visually decrement for each spin or bonus game outcome. For wagering embodiments, these spins may be free spins that do not require additional wagers to play the bonus game. It is to be understood that the spin counter 524 may convey the duration of the bonus game in another suitable visual manner, such as beginning from one or zero and incrementing towards a termination count. Dynamic bonus game durations may be at least partially based on game events and/or conditions occurring within the bonus game, such as a special symbol or combination of symbols that adds additional spins to or resets the spin counter 524.

FIG. 8D depicts the bonus game interface during a first bonus game outcome. In particular, the array 510 has been populated with symbols from the one or more sets of available symbols associated with the bonus game. In at least some embodiments, in addition to the standard slot-based symbols, the bonus sets of available symbols include special symbols such as wilds, value-bearing symbols, and/or state symbols associated with at least any active persistent elements. In certain embodiments, the value-bearing symbols are configured to be held or locked into the symbol array 510 for at least one subsequent bonus game outcome until an award event is triggered, such as the conclusion of the bonus game or detecting a catalyst symbol or game event, and the like. In other embodiments, the value-bearing symbols are awarded and/or removed within a single outcome (i.e., the value-bearing symbols are not held).

In the example embodiment, the first bonus game outcome includes a plurality of symbols occupying the array 510 that includes a first state symbol 528 and a second state symbol 530. The first state symbol 528, as indicated by the matching or linked presentation, is associated with the first persistent element 512, and the second state symbol 530 is associated with the third persistent element 516. In the illustrated bonus game instance, the first persistent element 512 is active, and the third persistent element 516 is inactive. In some embodiments, the available symbols for the bonus game includes state symbols for inactive persistent elements. The state symbols associated with the inactive persistent elements may be configured to provide functionality similar to the state symbols of the base game (e.g., perceived persistence, state change, etc.) and/or provide a means for inactive persistent elements to become active to join the current bonus game instance. In certain embodiments, activating one or more persistent elements during the bonus game instance may cause the spin counter 524 to be reset or an independent spin counter is initiated for the newly activated persistent element, where the bonus game concludes when all spin counters have expired.

In the example embodiment, the first state symbol 528 is associated with a symbol trigger event that, in response to the game-logic circuitry detecting the symbol trigger event, causes the game-logic circuitry to apply the game enhancement of one or more persistent elements associated with the symbol trigger event. The symbol trigger event may include detecting a threshold number of state symbols (e.g., one) in a bonus game outcome. In certain embodiments, similar to the game events of the base game, the symbol trigger event is a two-step determination, where detecting the threshold number of state symbols causes the game-logic circuitry to generate one or more random values or other random variables to determine whether or not to activate a symbol trigger event. In the example embodiment, the symbol trigger event is only available for active persistent elements. In certain embodiments, converting an inactive persistent element to an active state automatically initiates a corresponding symbol trigger event.

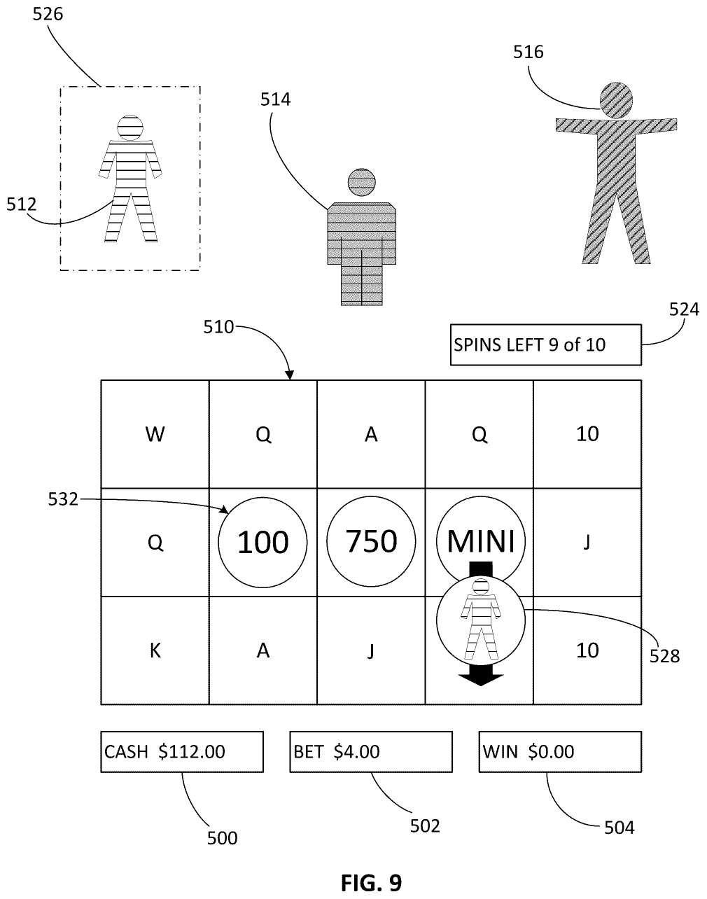

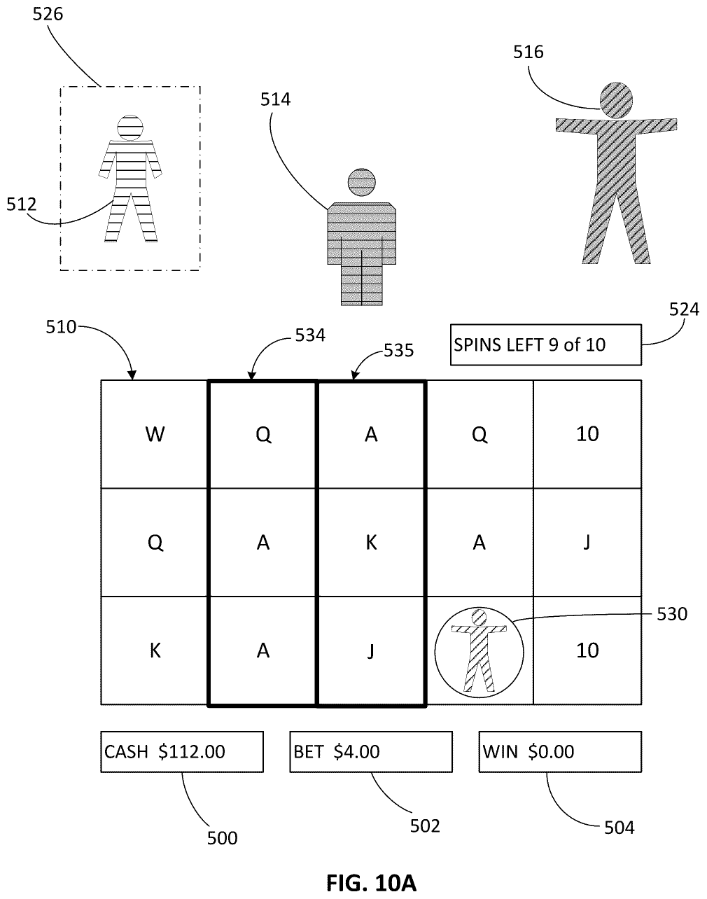

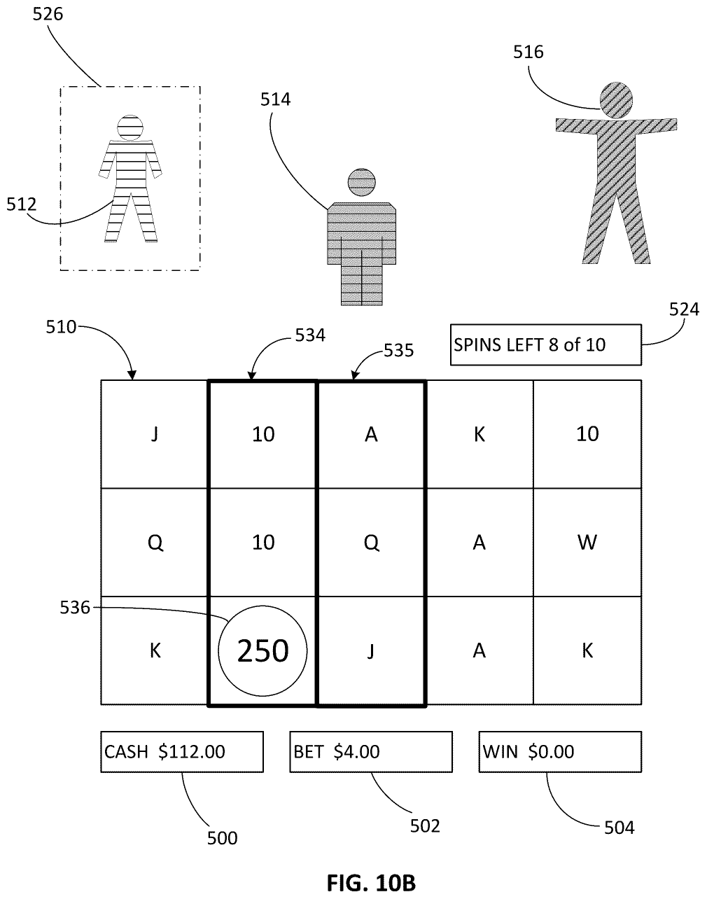

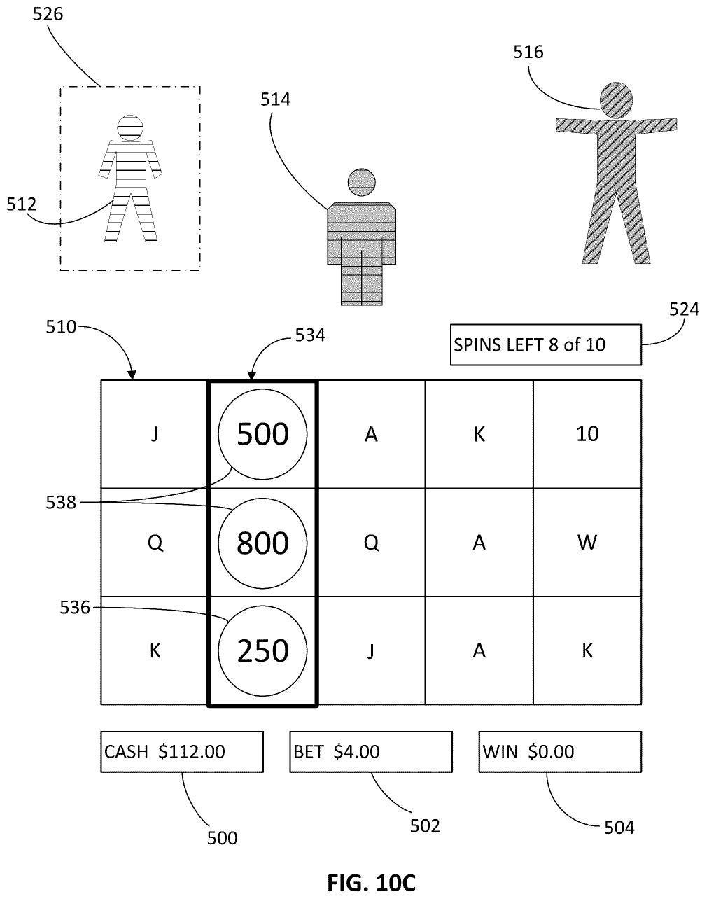

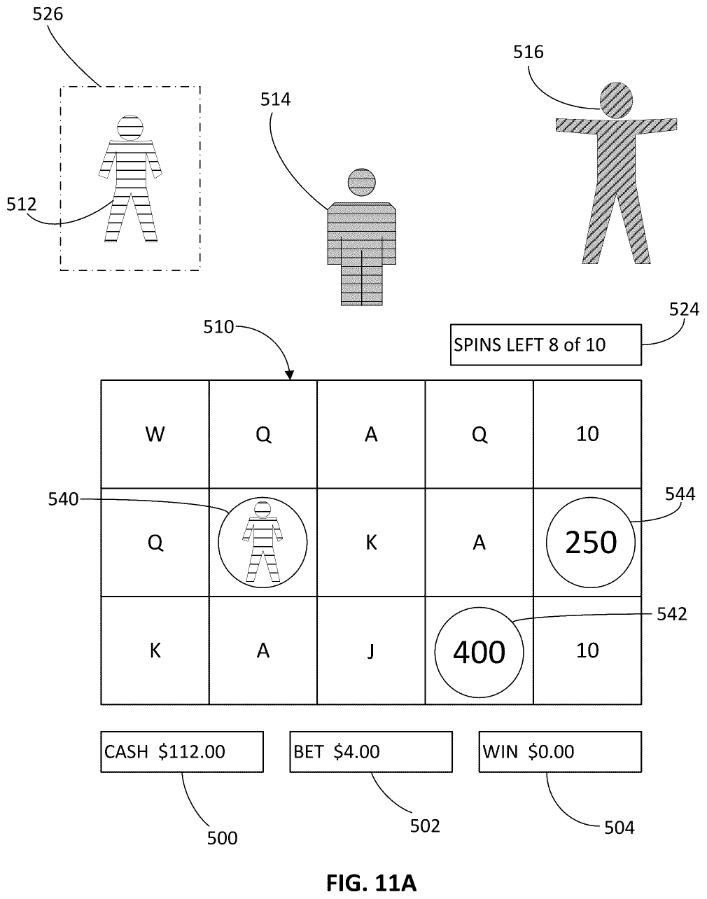

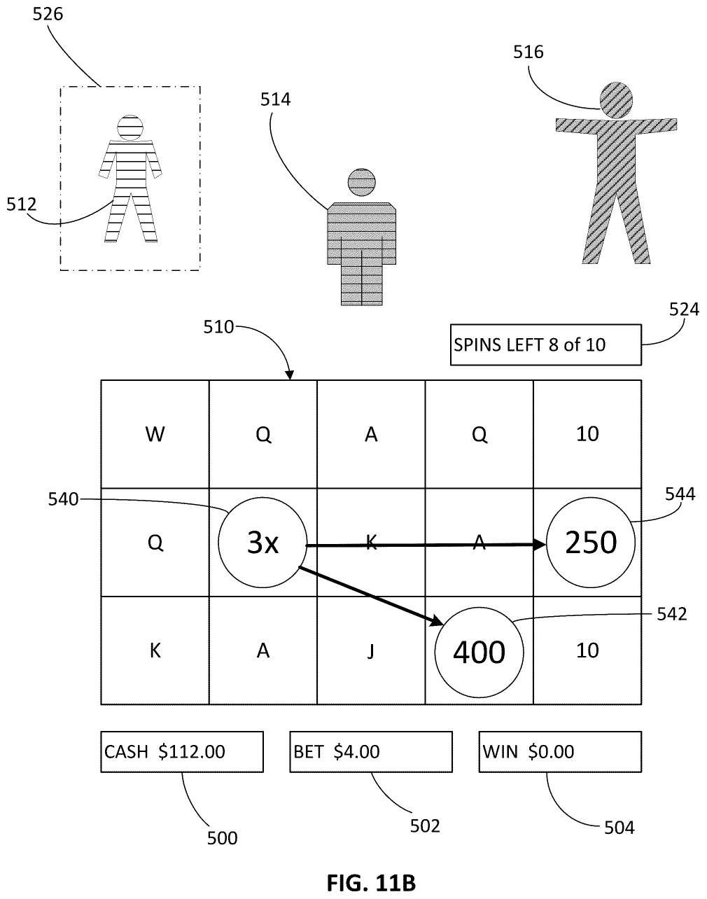

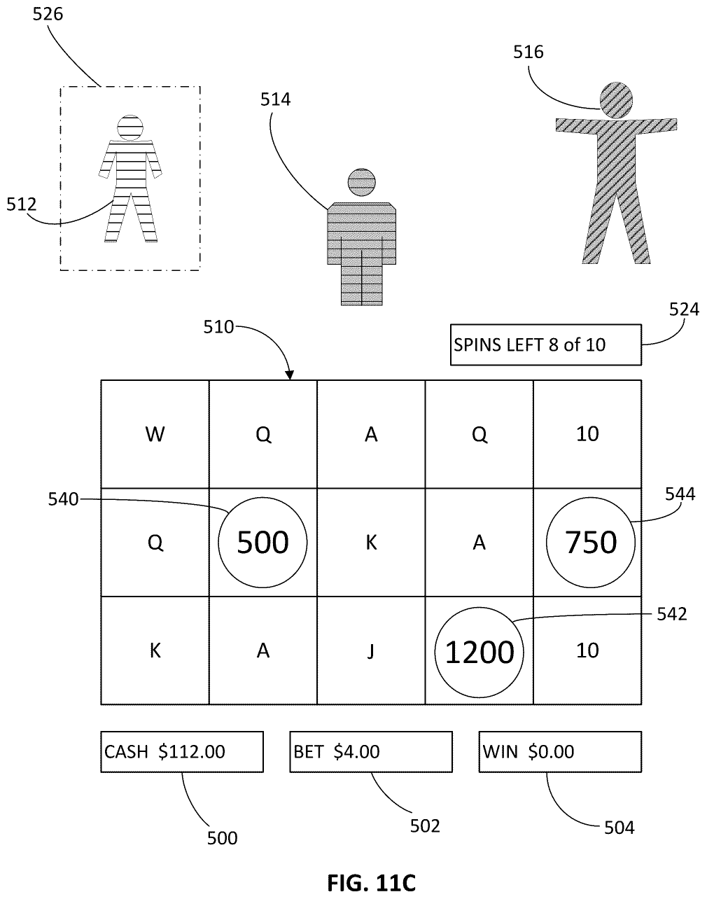

FIGS. 9-11C depict example game enhancements that may result from the symbol trigger event of FIG. 8D. That is, FIG. 9 depicts a first example game enhancement, FIGS. 10A-10C depict a second example game enhancement, and FIGS. 11A-11C depict a third example game enhancement. It is to be understood that the illustrated game enhancements are for exemplary purposes only and are not intended to limit the form and/or function of the game enhancements contemplated by the present disclosure. That is, the game enhancement may include additional, fewer, or alternative functions and/or presentations, including those described elsewhere herein.

FIG. 9 depicts the bonus game interface with the first example game enhancement. In the example embodiment, the first game enhancement replaces one or more symbols within the array 510 with value-bearing symbols 532 (including a value-bearing symbol with indica indicating a “MINI” progressive jackpot award) and/or other suitable symbols. In the example embodiment, the replaced symbols are selected at least partially on the relative position of the state symbol 528 that is associated with the symbol trigger event. The presentation assembly is configured to present a game enhancement sequence that animates the state symbol 528 to move along a path defined across the array 510 and replace any symbols in the positions traveled by the symbol 528 with the value-bearing symbols 532. The path may be predefined, partially random, or fully random. For example, the number of symbol positions to be traveled may be predefined while the particular symbol positions to traverse are randomly selected.

In other embodiments, other suitable replacement schemes may be used. In one example, any symbol positions adjacent to the original position of the state symbol 528 are populated with the value-bearing symbols 532. In another example, the symbol positions in a row and/or column occupied by the state symbol 528 are populated with the value-bearing symbols 528. In a further example, the symbol positions and/or symbols include a background, color, watermark, and/or other suitable visual identifier that visually defines a subset of linked symbol positions, and any subset including the state symbol 528 is replaced with value-bearing symbols. In some embodiments, if a symbol position designated to be occupied with a new value-bearing symbol is already occupied with a preexisting value-bearing symbol, another special symbol, and/or a symbol within a winning symbol combination, the replacement may be skipped, applied after the corresponding function of the underlying symbol is applied to the outcome, or the underlying symbol is enhanced with the newly-added value-bearing symbol. For example, a previously-held value-bearing symbol within the path of the state symbol 528 may be updated to increase the prior value with a value generated for an overlapping newly-added value-bearing symbol.

The first game enhancement is configured to vary based on the current state of the first persistent element 512. More specifically, in the example embodiment with a progression path of states, as the current state increases, the potential value of the first game enhancement increases. For example, the number of symbol positions traveled or symbols to replace may increase as the current state increases and/or the current state changes the range or set of available values for generating the value-bearing symbols, where higher states have a set or range of available values having a greater average value relative to an initial state. Other suitable variations may be additionally or alternatively applied with the game enhancement sequence, such as awarding additional spins, converting symbols to guarantee a winning symbol combination, and the like.

FIGS. 10A-10C depict the second example game enhancement. More specifically, the second game enhancement defines one or more award regions within the symbol array 510 that, in response to being populated by a subsequent value-bearing symbol, state symbol, and/or other suitable catalyst symbol, causes at least a portion of the respective award region to be populated with value-bearing symbols and/or other suitable symbols, such as wild symbols or symbols that guarantee at least one winning symbol combination.

The award region game enhancement varies based on the current state of the persistent element 512. In some embodiments, a number of award regions and/or a number of symbol positions within an award region change based on the current state. In other embodiments, the set of available symbols or awards that are applied to the award regions changes based on the current state, where increasing states cause the set or sets of available symbols or awards to increase in potential value. In the example embodiment, each award region encapsulates a column of the symbol array 510, and increasing the state of the persistent element 512 results in additional award regions and/or the award region expanding. In other embodiments, the award regions may be defined for a different subset of the symbol array 510, such as a row, single symbol position, or a group of non-adjacent symbol positions.

FIG. 10A depicts the bonus game interface in a first state following the symbol trigger event of FIG. 8D with active award regions. More specifically, because the persistent element 512 is in a second state, two award regions 534, 535 are defined for the second and third columns of the symbol array 510 as indicated by the bold outline. Other suitable visual presentations may be used to visually indicate the award regions 534, 535 according to the particular theme and/or configuration of the bonus game. In at least some embodiments, at least one of the award regions 534, 535 is defined based on the symbol trigger event. In the example embodiment, referring back to FIG. 8D, the symbol trigger event included detecting the state symbol 528 in the second column. The award region 534 is defined to include the symbol position occupied by the state symbol 528, and the second award region 535 may be defined to be adjacent to the first award region 534 or randomly applied to a different column of the array 510. In the illustrated embodiment, the state symbol 528 is removed from the array 510 in response triggering the game enhancement sequence.

The award regions 534, 535 are configured to persist within the bonus game for at least one subsequent game outcome to provide the functionality described herein. In some embodiments, the symbol replacement functionality of the award regions 534, 535 is immediately available when the regions 534, 535 are initiated (e.g., a value-bearing symbol or other state symbol populates the newly initiated regions 534, 535 in the outcome shown in FIG. 10A). The duration of the award regions 534, 535 may be static or dynamic (e.g., extendable via subsequent game events in the bonus game). The duration of the regions 534, 535 may be independent of each other. That is, each award region 534, 535 may be initiated with a different initial duration and/or extended independently. In certain embodiments, the current state of the persistent element 512 may define an initial duration of the award regions 534, 535. In some embodiments, the player may be prompted to provide input to select an award region configuration (e.g., duration, position in the array 510, number of positions, etc.) from a set of available configurations.

FIG. 10B depicts the bonus game interface presenting a bonus game outcome following the award regions being initiated in FIG. 10A. The symbol array 510 is populated with new symbols, and the spin counter 524 is updated to visually indicate that a spin or outcome has been generated. The symbols of the bonus game outcome in FIG. 10B include a new value-bearing symbol 536 within the first award region 534 while there is no value-bearing symbol within the second award region 536.

In the example embodiment, the award regions 534, 535 are configured to persist for a single subsequent game outcome (i.e., the game outcome shown in FIG. 10B) to determine whether or not the corresponding award functionality is activated. The value-bearing symbol 536 is a trigger for the corresponding award event of the first award region 534 as described herein, while the second award region 535 lacks a corresponding trigger. Accordingly, an award sequence is initiated for the first award region 534 and the second award region 535 is removed prior to the next bonus game outcome.

FIG. 10C depicts the result of the award region determinations of the game outcome shown in FIG. 10B. More specifically, the first award region 534 is populated with additional value-bearing symbols 538, and the expired second award region is removed from the symbol array 510. In certain embodiments, the values of the new value-bearing symbols 538 may be generated at least partially as a function of the value of the trigger value-bearing symbol 536.

In the example embodiment, the entire column of the first award region 534 is populated with value-bearing symbols 538. In other embodiments, one or more symbol positions within the award region 534 may remain unpopulated with value-bearing symbols, such as positions including symbols already associated with an award (e.g., a winning symbol combination). In certain embodiments in which the value-bearing symbols 538 replace other symbols, the game-logic circuitry may be configured to perform one or more outcome determinations with the initial symbol before replacing the initial symbol with a value-bearing symbol. In some embodiments, if the award region 534 has a preexisting value-bearing symbol, the value of the preexisting value-bearing symbol may be enhanced with the value determined for a new value-bearing symbol 538 at the given position with the region 534.

The value-bearing symbols 536, 538 are awarded and removed during a corresponding award sequence. The award sequence may occur prior to the next bonus game outcome or at the conclusion of bonus game. In embodiments with delayed award sequences, the value-bearing symbols 536, 538 may be held within the symbol array 510 and/or the bonus game interface includes one or more presentation elements to track awards accumulated over the duration of the bonus game. In certain embodiments, the value-bearing symbols 536, 538 do not automatically result in an award, but instead are awarded responsive to one or more additional trigger events and/or conditions. For example, the value-bearing symbols 536, 538 may be awarded in response to a predefined threshold number of held value-bearing symbols being reached or a catalyst symbol being detected in the array 510.

FIGS. 11A-11C depict a third example game enhancement sequence. More specifically, the third game enhancement is configured to apply a multiplier to one or more award values, such as the values of one or more value-bearing symbols within the symbol array 510. FIG. 11A depicts a bonus game outcome subsequent to the outcome shown in FIG. 8D. The bonus game outcome includes a state symbol 540 associated with the active first persistent element 512 and two value-bearing symbols 542, 544. The game-logic circuitry, in response to detecting the state symbol 540, determines a symbol trigger event is present within the game outcome, and the game-logic circuitry automatically initiates the game enhancement sequence.

FIG. 11B depicts a first state of the example game enhancement sequence. In the example embodiment, the state symbol 540 associated with the symbol trigger event is updated to visually indicate a multiplier to be applied to at least one value-bearing symbol present within the symbol array 510. In some embodiments, value-bearing symbols are selectively held within the symbol array 510 for a plurality of game outcomes or until the end of the bonus game, and the held value-bearing symbols are eligible to be multiplied within the game enhancement sequence. In other embodiments, value-bearing symbols are not held, but rather the multiplier is only applied to value-bearing symbols occupying the symbol array 510 for the same spin or outcome as the symbol trigger event. In certain embodiments, the multiplier is applied to additional or alternative values, such as the next award collected during the bonus game or an aggregate award collected over the duration of the bonus game.

The game enhancement sequence includes one or more animations that visually update the value-bearing symbols 542, 544 based on the multiplier of the state symbol 540. In one example, the multiplier indicia and/or the state symbol is animated to move towards or otherwise visually link to each of the value-bearing symbols 542, 544. In the example embodiment, every value-bearing symbol present within the array 510 is multiplied by the multiplier once. In other embodiments, the multiplier may be applied to a symbol multiple times and/or some value-bearing symbols may be omitted from the enhancement. In one example, the game-logic circuitry determines the number of times the multiplier is applied and randomly selects value-bearing symbols to receive the multiplier.

FIG. 11C depicts a second state of the game enhancement sequence. More specifically, the multiplier of the state symbol 540 has been applied to the value-bearing symbols 542, 544, and the award indicia of the value-bearing symbols 542, 544 have been updated to reflect the new respective award values. In the example embodiment, the state symbol 540 is converted to a value-bearing symbol from the game enhancement sequence. In other embodiments, the state symbol 540 is removed prior to a subsequent game outcome without being converted. The value-bearing symbols 542, 544 (and the converted state symbol 540) are configured to be held within the array 510 until the conclusion of the bonus game, where the game-logic circuitry initiates an award sequence to provide an aggregate award based on the held symbols. In other embodiments, the value-bearing symbols are not held, and the award sequence may be presented via the presentation assembly prior to a subsequent bonus game outcome. In further embodiments, additional trigger events and/or conditions may be required to provide an award associated with the value-bearing symbols (e.g., collecting a threshold number of value-bearing symbols, detecting a catalyst symbol, etc.).

The third example game enhancement is configured to vary based on the state of the associated persistent element (i.e., the persistent element 512). For example, each state may have a corresponding multiplier value, where the multiplier value increases as the persistent element state increases along a progression path. In the illustrated embodiment, the persistent element 512 is in a second state, and the multiplier value is 3×, which is greater than the 2× multiplier value of a first state and less than the 5× multiplier value of a subsequent third state. Additional or alternative multiplier values may be used in other embodiments. In some embodiments, the game enhancement sequence varies via additional or alternative variables, such as the number of value-bearing symbols selected to be multiplied. In certain embodiments, the third game enhancement may include generating new value-bearing symbols, particularly for game outcomes having a number of value-bearing symbols less than the number of multipliers to be applied to the game outcome. Although FIGS. 11A-11C are depicted using multipliers, it is to be understood that the functionality of the game enhancement may be used for additional or alternative awards or enhancements. For example, and without limitation, the game enhancement may apply or award free spins, special symbols, credit awards (i.e., values aggregated with the preexisting value of the value-bearing symbols), trigger symbols, prize board pick opportunities, and/or the like. In certain embodiments, the value-bearing symbols may include predetermined levels of value that can be selectively upgraded in response to the game enhancement (e.g., a value-bearing symbol at a first level has a value of 100, which can be upgraded to a second level having a value of 250).

Embodiments of the present invention comprise an innovative application of data processing steps that, when implemented by game-logic circuitry, direct a presentation assembly to present a set of dynamic persistence, perceived persistence, trigger, and award processes that minimizes processing overhead by utilizing readily understood visual game elements and numbered indicia to represent credit values instead of complex, fanciful game images. Further, the process may collect displayed values borne by special symbols (i.e., value-bearing symbols) in a clear, visual manner. The state-based persistent elements, state symbols, and value-bearing symbols provide building blocks for innumerable different collection, triggering, and awarding sequences simply by manipulating the criteria associated with these visual game elements, resulting in fewer rules needed for the award process than would be necessary for calculating values of winning symbol combinations enumerated in stored paytables, as found in prior art reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-award process that can be easily adapted to any theme/brand while remaining easily understood by players.

The gaming systems and methods described above facilitate a streamlined for providing a plurality of game features to a game through readily understood presentation elements and animations viewable by a player during play of the game. Moreover, the persistent elements and the corresponding functionality can be tailored to facilitate a plurality of different actions responsive to a single (or single set) of random determinations generated by game-logic circuitry, thereby reducing the computing overhead required to facilitate an enhanced set of functions and/or mechanics within a game. In contrast, typical reel-based games.

In stark contrast, in typical free spin bonuses, overlapping payline sections require multiple evaluation steps. Often, analysis is required to determine which payline results in the highest credit total, with the lesser value paylines being discarded but only after being evaluated-all this adds to processing overhead. Special symbols like wilds, multipliers, and scatter symbols can modify paytable values and may require separate, additional evaluation according to customized rule sets. All these procedures can be inherently more complex than the bonus game embodiments disclosed herein. The embodiments disclosed herein involve simple detection of special state symbols with predefined functions that are triggered through a unified or streamlined random determinations. This represents a win-win: simpler, almost self-explanatory graphics combined with faster, more efficient processing.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine of a gaming system, the gaming system comprising game-logic circuitry and a presentation assembly of the gaming machine, wherein the method comprises:
presenting, by the presentation assembly, a plurality of symbol-bearing reels, a symbol array, and a plurality of persistent elements external to the symbol array, each of the plurality of persistent elements having a respective set of visual states and uniquely associated with a respective state symbol type of the plurality of symbol-bearing reels, wherein a current visual appearance of a state symbol of the respective state symbol type is dynamically linked to a current visual state of the associated persistent element; and
generating and presenting, via the game-logic circuitry and the presentation assembly, one or more game outcomes, each of the one or more game outcomes comprising:
spinning and stopping, via the presentation assembly, the plurality of symbol-bearing reels to land symbols from the symbol-bearing reels in the symbol array;
in response to the landed symbols including a state change event associated with a first persistent element of the plurality of persistent elements, animating the first persistent element to change from a first visual state to a second visual state of the respective set of visual states associated with the first persistent element, wherein the current visual appearance of subsequent state symbols of the respective state symbol type associated with the first persistent element is updated to be linked to the second visual state of the first persistent element; and
in response to detecting a symbol trigger event including at least one state symbol of the respective state symbol type associated with the first persistent element, presenting, by the presentation assembly, a game enhancement sequence for a game enhancement applied to at least one game outcome, wherein the game enhancement is associated with the first persistent element and the at least one state symbol and varies based on the current visual state of the first persistent element.

2. The method of claim 1, wherein the set of visual states are organized into a predefined progression path, and wherein the game enhancement is configured to increase in potential value along each progressive visual state of the predefined progression path.

3. The method of claim 2 further comprising, in response to detecting a reset event associated with the first persistent element, animating, via the presentation assembly, the first persistent element to change to an initial visual state of the predefined progression path.

4. The method of claim 1, wherein the one or more game outcomes includes at least one base game outcome of a base game and at least one bonus game outcome of a bonus game, and wherein the symbol trigger event becomes available in response to transitioning from the base game to the bonus game.

5. The method of claim 4 further comprising:
detecting, by the game-logic circuitry and within the at least one base game outcome, a bonus trigger event;
randomly determining, by the game-logic circuitry, whether or not to activate the bonus game in response to the bonus trigger event; and
in response to the random determination indicating that the bonus game is to be activated, transitioning, by the presentation assembly, the symbol array and at least one persistent element of the plurality of persistent elements to a bonus game interface, the bonus game interface including a set of bonus symbol-bearing reels.

6. The method of claim 1, wherein the game enhancement is applied based at least partially on a respective position of the at least one state symbol within the symbol array.

7. The method of claim 1, wherein the symbol trigger event includes a state symbol associated with a second persistent element, and wherein the game enhancement sequence includes applying a second game enhancement associated with the second persistent element to the at least one game outcome.

8. A gaming machine comprising:
a presentation assembly configured to present a plurality of symbol-bearing reels, a symbol array, and a plurality of persistent elements external to the symbol array, each of the plurality of persistent elements having a respective set of visual states and uniquely associated with a respective state symbol type of the plurality of symbol-bearing reels, wherein a current visual appearance of a state symbol of the respective state symbol type is dynamically linked to a current visual state of the associated persistent element; and
game-logic circuitry in communication with the presentation assembly, the game-logic circuitry configured to generate one or more game outcomes and cause the presentation assembly to present the one or more game outcomes, each of the one or more game outcomes comprising the steps of:
spinning and stopping, via the presentation assembly, the plurality of symbol-bearing reels to land symbols from the symbol-bearing reels in the symbol array;
in response to the landed symbols including a state change event associated with a first persistent element of the plurality of persistent elements, animating the first persistent element to change from a first visual state to a second visual state of the respective set of visual states associated with the first persistent element, wherein the current visual appearance of subsequent state symbols of the respective state symbol type associated with the first persistent element is updated to be linked to the second visual state of the first persistent element; and
in response to detecting a symbol trigger event including at least one state symbol of the respective state symbol type associated with the first persistent element, presenting, by the presentation assembly, a game enhancement sequence for a game enhancement applied to at least one game outcome, wherein the game enhancement is associated with the first persistent element and the at least one state symbol and varies based on the current visual state of the first persistent element.

9. The gaming machine of claim 8, wherein the set of visual states are organized into a predefined progression path, and wherein the game enhancement is configured to increase in potential value along each progressive visual state of the predefined progression path.

10. The gaming machine of claim 9, wherein generating and presenting the one or more game outcomes further comprises animating, via the presentation assembly and in response to detecting a reset event associated with the first persistent element, the first persistent element to change to an initial visual state of the predefined progression path.

11. The gaming machine of claim 8, wherein the one or more game outcomes includes at least one base game outcome of a base game and at least one bonus game outcome of a bonus game, and wherein the symbol trigger event becomes available in response to transitioning from the base game to the bonus game.

12. The gaming machine of claim 11, wherein generating and presenting the one or more game outcomes further comprises:
detecting, by the game-logic circuitry and within the at least one base game outcome, a bonus trigger event;
randomly determining, by the game-logic circuitry, whether or not to activate the bonus game in response to the bonus trigger event; and
in response to the random determination indicating that the bonus game is to be activated, transitioning, by the presentation assembly, the symbol array and at least one persistent element of the plurality of persistent elements to a bonus game interface, the bonus game interface including a set of bonus symbol-bearing reels.

13. The gaming machine of claim 8, wherein the game enhancement is applied based at least partially on a respective position of the at least one state symbol within the symbol array.

14. The gaming machine of claim 8, wherein the symbol trigger event includes a state symbol associated with a second persistent element, and wherein the game enhancement sequence includes applying a second game enhancement associated with the second persistent element to the at least one game outcome.

15. A gaming system comprising:
a gaming machine comprising a presentation assembly configured to present a plurality of symbol-bearing reels, a symbol array, and a plurality of persistent elements external to the symbol array, each of the plurality of persistent elements having a respective set of visual states and uniquely associated with a respective state symbol type of the plurality of symbol-bearing reels, wherein a current visual appearance of a state symbol of the respective state symbol type is dynamically linked to a current visual state of the associated persistent element; and
game-logic circuitry in communication with the presentation assembly, the game-logic circuitry configured to generate one or more game outcomes and cause the presentation assembly to present the one or more game outcomes, each of the one or more game outcomes comprising the steps of:
spinning and stopping, via the presentation assembly, the plurality of symbol-bearing reels to land symbols from the symbol-bearing reels in the symbol array;
in response to the landed symbols including a state change event associated with a first persistent element of the plurality of persistent elements, animating the first persistent element to change from a first visual state to a second visual state of the respective set of visual states associated with the first persistent element, wherein the current visual appearance of subsequent state symbols of the respective state symbol type associated with the first persistent element is updated to be linked to the second visual state of the first persistent element; and
in response to detecting a symbol trigger event including at least one state symbol of the respective state symbol type associated with the first persistent element, presenting, by the presentation assembly, a game enhancement sequence for a game enhancement applied to at least one game outcome, wherein the game enhancement is associated with the first persistent element and the at least one state symbol and varies based on the current visual state of the first persistent element.

16. The gaming system of claim 15, wherein the set of visual states are organized into a predefined progression path, and wherein the game enhancement is configured to increase in potential value along each progressive visual state of the predefined progression path.

17. The gaming system of claim 16, wherein generating and presenting the one or more game outcomes further comprises animating, via the presentation assembly and in response to detecting a reset event associated with the first persistent element, the first persistent element to change to an initial visual state of the predefined progression path.

18. The gaming system of claim 15, wherein the one or more game outcomes includes at least one base game outcome of a base game and at least one bonus game outcome of a bonus game, and wherein the symbol trigger event becomes available in response to transitioning from the base game to the bonus game.

19. The gaming system of claim 18, wherein generating and presenting the one or more game outcomes further comprises:
detecting, by the game-logic circuitry and within the at least one base game outcome, a bonus trigger event;
randomly determining, by the game-logic circuitry, whether or not to activate the bonus game in response to the bonus trigger event; and
in response to the random determination indicating that the bonus game is to be activated, transitioning, by the presentation assembly, the symbol array and at least one persistent element of the plurality of persistent elements to a bonus game interface, the bonus game interface including a set of bonus symbol-bearing reels.

20. The gaming system of claim 15, wherein the game enhancement is applied based at least partially on a respective position of the at least one state symbol within the symbol array.

21. The gaming system of claim 15, wherein the symbol trigger event includes a state symbol associated with a second persistent element, and wherein the game enhancement sequence includes applying a second game enhancement associated with the second persistent element to the at least one game outcome.
